(19) United States
(12) Patent Application Publication
(10) Pub. No.: US 2020/0130400 A1
(43) Pub. Date: Apr. 30, 2020

(54) FOLDER DESIGN

(71) Applicant: Blank Acquisition, LLC d/b/a Blanks/USA, Brooklyn Park, MN (US)

(72) Inventor: Andrew R. Ogren, Woodbury, MN (US)

(21) Appl. No.: 16/173,696

(22) Filed: Oct. 29, 2018

(51) Int. Cl. B42F 7/06

(52) U.S. Cl. CPC B42F 7/06; B42P 2261/00

(57) ABSTRACT

A folder blank includes a first body panel, a second body panel connected to the first body panel, a first pocket panel connected to the first body panel, a first diagonal line extending across the first pocket panel, a first horizontal scored line connected to the first diagonal line and extending across the first pocket panel, and a first dividing line extending between the first body panel and the first pocket panel. The first dividing line includes a first vertical cut line and a first vertical scored line in alignment with and connected to the first vertical cut line. The first pocket panel can be folded about the first dividing line, the first diagonal line, and the first horizontal scored line to move the first pocket panel from a vertical position to a horizontal position on the folder.

### BACKGROUND

The present invention relates to printable blank sheets, and in particular, to printable blank sheets that are capable of being formed into folders.

Custom print materials have become a common way for businesses to market themselves. Custom print materials that are typically used in advertising include two-dimensional products like postcards, flyers, and door hangers, as well as three-dimensional products like golf ball boxes, candy boxes and pop-up calendars. Typically, custom print materials are sent to print shops that specialize in preparing custom print materials, as the materials have had to be printed and assembled by specialized machines. As a result, having custom print materials made can be costly and time-consuming. Further, specialty print shops typically require custom print materials to be ordered in large amounts.

### SUMMARY

A folder blank includes a first body panel, a second body panel connected to the first body panel, a first pocket panel connected to the first body panel, a first diagonal line extending across the first pocket panel, a first horizontal scored line connected to the first diagonal line and extending across the first pocket panel, and a first dividing line extending between the first body panel and the first pocket panel. The first dividing line includes a first vertical cut line and a first vertical scored line in alignment with and connected to the first vertical cut line. The first pocket panel can be folded about the first dividing line, the first diagonal line, and the first horizontal scored line to move the first pocket panel from a vertical position to a horizontal position on the folder.

A method for creating a custom folder includes folding a first pocket panel of a folder blank along a first dividing line of the folder blank. The folder blank includes a first body panel connected to the first pocket panel, a second body panel connected to the first body panel, a first diagonal line extending across the first pocket panel, and a first horizontal scored line connected to the first diagonal line and extending across the first pocket panel. The first dividing line extends between the first body panel and the first pocket panel. The first dividing line includes a first vertical cut line and a first vertical scored line in alignment with and connected to the first vertical cut line. The method further includes folding the first pocket panel along the first diagonal line to move the first pocket panel from a vertical position to a horizontal position, and folding the first pocket panel along the first horizontal scored line.

### BRIEF DESCRIPTION OF THE DRAWINGS

FIG. 1 is a top plan view of a printable blank sheet with a folder blank.

FIG. 2 is a flow chart showing a method for forming a folder from the printable blank sheet.

FIG. 3A is a perspective view of the printable blank sheet as it is being run through a printer.

FIG. 3B is a top plan view of the folder blank after it has been removed from the printable blank sheet.

FIG. 3C is a top plan view of the folder blank after a first pocket panel and a second pocket panel have been folded along a first dividing line and a second dividing line.

FIG. 3D is a top plan view of the folder blank after the first pocket panel and the second pocket panel have been folded along a first diagonal perforated line and a second diagonal perforated line.

FIG. 3E is a top plan view of the folder blank after the first pocket panel and the second pocket panel have been folded along a first horizontal scored line and a second horizontal scored line.

FIG. 3F is a top plan view of the folder blank as a first adhesive cover and a second adhesive cover are removed from a first tab and a second tab.

FIG. 3G is a top plan view of the folder blank after the first tab and the second tab have been folded along a first tab scored line and a second tab scored line and adhered to the first pocket panel and the second pocket panel.

FIG. 4 is a flow chart showing an alternative method for forming a folder from the printable blank sheet.

FIG. 5A is a perspective view of the printable blank sheet as it is being run through a printer.

FIG. 5B is a top plan view of the folder blank after it has been removed from the printable blank sheet.

FIG. 5C is a bottom plan view of the folder blank.

FIG. 5D is a bottom plan view of the folder blank after the first tab and the second tab have been folded along a first tab scored line and a second tab scored line.

FIG. 5E is a bottom plan view of the folder blank as a first adhesive cover and a second adhesive cover are removed from a first tab and a second tab.

FIG. 5F is a bottom plan view of the folder blank after a first pocket panel and a second pocket panel have been folded along a first dividing line and a second dividing line.

FIG. 5G is a bottom plan view of the folder blank after the first pocket panel and the second pocket panel have been folded along a first diagonal perforated line and a second diagonal perforated line.

FIG. 5H is a bottom plan view of the folder blank after the first pocket panel and the second pocket panel have been folded along a first horizontal scored line and a second horizontal scored line.

FIG. 5I is a bottom plan view of the folder blank after the first tab and the second tab have been adhered to the first pocket panel and the second pocket panel.

FIG. 6 is a side elevation view of a slit-over-perforation line in the printable blank sheet.

FIG. 7 is a top plan view of a second embodiment of a printable blank sheet with a folder blank.

FIG. 8 is a flow chart showing a method for forming a folder from the printable blank sheet of FIG. 7.

FIG. 9A is a perspective view of the printable blank sheet of FIG. 7 as it is being run through a printer.

FIG. 9B is a top plan view of the folder blank of FIG. 5 after it has been removed from the printable blank sheet.

FIG. 9C is a top plan view of the folder blank of FIG. 5 after a first pocket panel and a second pocket panel have been folded along a first dividing line and a second dividing line.

FIG. 9D is a top plan view of the folder blank of FIG. 5 after the first pocket panel and the second pocket panel have been folded along a first diagonal perforated line and a second diagonal perforated line.

FIG. 9E is a top plan view of the folder blank of FIG. 5 after the first pocket panel and the second pocket panel have been folded along a first horizontal scored line and a second horizontal scored line.

FIG. 9F is a top plan view of the folder blank of FIG. 5 as a first adhesive cover and a second adhesive cover are removed from a first tab and a second tab.

FIG. 9G is a top plan view of the folder blank of FIG. 5 after the first tab and the second tab have been folded along a first tab scored line and a second tab scored line and adhered to the first pocket panel and the second pocket panel.

FIG. 10 is a flow chart showing an alternative method for forming a folder from the printable blank sheet of FIG. 7.

FIG. 11A is a perspective view of the printable blank sheet as it is being run through a printer.

FIG. 11B is a top plan view of the folder blank after it has been removed from the printable blank sheet.

FIG. 11C is a bottom plan view of the folder blank.

FIG. 11D is a bottom plan view of the folder blank after the first tab and the second tab have been folded along a first tab scored line and a second tab scored line.

FIG. 11E is a bottom plan view of the folder blank as a first adhesive cover and a second adhesive cover are removed from a first tab and a second tab.

FIG. 11F is a bottom plan view of the folder blank after a first pocket panel and a second pocket panel have been folded along a first dividing line and a second dividing line.

FIG. 11G is a bottom plan view of the folder blank after the first pocket panel and the second pocket panel have been folded along a first diagonal perforated line and a second diagonal perforated line.

FIG. 11H is a bottom plan view of the folder blank after the first pocket panel and the second pocket panel have been folded along a first horizontal scored line and a second horizontal scored line.

FIG. 11I is a bottom plan view of the folder blank after the first tab and the second tab have been adhered to the first pocket panel and the second pocket panel.

### DETAILED DESCRIPTION

In general, the present disclosure relates to a printable blank sheet for forming a folder that has folder blank with a pocket panel connected to a body panel by a dividing line made up of a vertical cut line in alignment with a vertical scored line. The pocket panel has a diagonal line about which the pocket panel can be folded to move the pocket panel from a vertical position to a horizontal position on the printable blank sheet. Because the pocket panels begin in a vertical position, the printable blank sheet fits in a large variety of personal printers while still being able to form folders with deep horizontal pockets for enhanced securement. The folder can also be quickly and easily assembled.

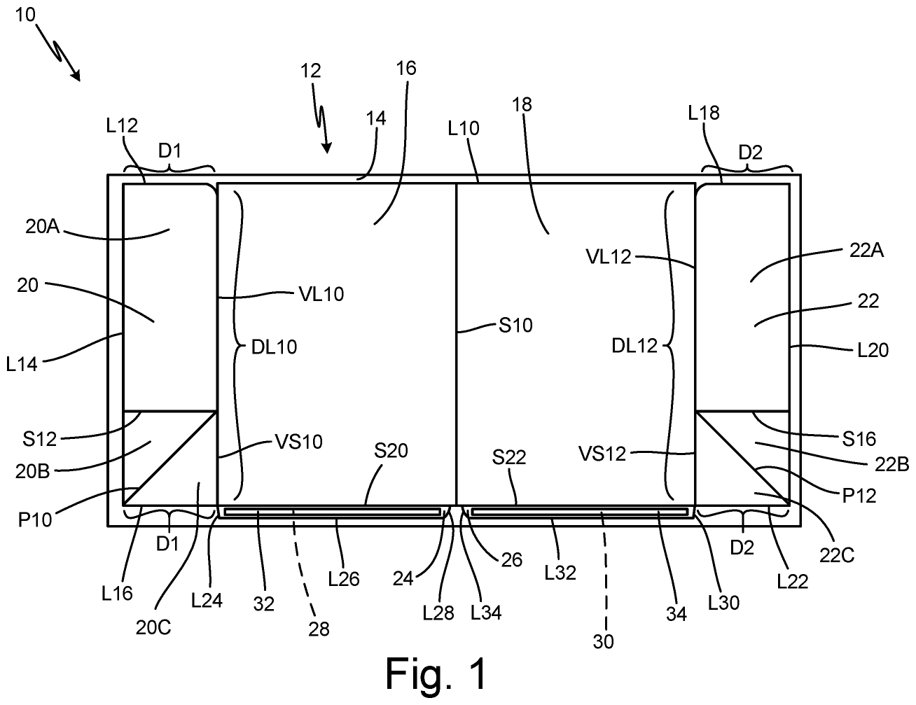

FIG. 1 is a top plan view of printable blank sheet 10 with folder blank 12. Printable blank sheet 10 includes folder blank 12, excess sheet area 14, and periphery cut lines L (including L10, L12, L14, L16, L18, L20, L22, L24, L26, L28, L30, L32, L34). Folder blank 12 includes first body panel 16, second body panel 18, first pocket panel 20, second pocket panel 22, first tab 24, second tab 26, first adhesive strip 28, second adhesive strip 30, first adhesive cover 32, second adhesive cover 34, first dividing line DL10 (including first vertical cut line VL10 and first vertical scored line VS10), second dividing line DL12 (including second vertical cut line VL12 and second vertical scored line VS12), scored lines S (including center scored line S10, first horizontal scored line S12, second horizontal scored line S16, first tab scored line S20, and second tab scored line S22), and perforated lines P (including first diagonal perforated line P10 and second diagonal perforated line P12). First pocket panel 20 includes first rectangular piece 20A, first upper triangular piece 20B, and first lower triangular piece 20C. Second pocket panel 22 includes second rectangular piece 22A, second upper triangular piece 22B, and second lower triangular piece 22C.

Printable blank sheet 10 is a flat sheet that is capable of being run through a printer. In this embodiment, printable blank sheet 10 includes a plurality of layers. In alternate embodiments, printable blank sheet 10 may be a single sheet. Printable blank sheet 10 may be made of uncoated paper, paper coated on one side, paper coated on both sides, material laminated on one side, material laminated on both sides, premium coated material, laminate, laminate conducive to printing, soft touch laminate, laminated leather, laminated foil, PET, premium Invercote, 80 pound digital gloss cover, 100 pound digital gloss cover, heavier stock (up to 24 point), a combination thereof, or any other suitable material or combination of materials. Folder blank 12 is positioned on, or held in, printable blank sheet 10 and is capable of being removed from printable blank sheet 10 to be assembled into a folder. Excess sheet area 14 surrounds folder blank 12 on printable blank sheet 10. After folder blank 12 has been removed from printable blank sheet 10, excess sheet area 14 can be discarded. Periphery cut lines L extend through printable blank sheet 10 and around folder blank 12 to define the periphery of folder blank 12 in printable blank sheet 10. Folder blank 12 can be removed from printable blank sheet 10 along periphery cut lines L. In this embodiment, periphery cut lines L are slit-over-perforation lines. In alternate embodiments, periphery cut lines L may be perforated lines, die-cut lines, or any other suitable cut line.

Folder blank 12 has first body panel 16 with a first side connected to second body panel 18 and a second side connected to first pocket panel 20. Second body panel 18 has a first side connected to first body panel 16 and a second side connected to second pocket panel 22. As such, first body panel 16 and second body panel 18 are between first pocket panel 20 and second pocket panel 22. First pocket panel 20 and second pocket panel 22 have dimensions D1 and D2, respectively. First pocket panel 20 and second pocket panel 22 are rectangular and extend vertically across printable blank sheet 10, as shown in FIG. 1. Dimensions D1 and D2 represent lengths of first pocket panel 20 and second pocket panel 22, respectively, in vertical positions. In alternate embodiments, first pocket panel 20 and second pocket panel 22 may be any suitable shape. A bottom of first body panel 16 is connected to first tab 24, and a bottom of second body panel 18 is connected to second tab 26. First adhesive strip 28 is positioned on first tab 24, and second adhesive strip 30 is positioned on second tab 26. First adhesive cover 32 is positioned over first adhesive strip 28 to cover first adhesive strip 28, and second adhesive cover 34 is positioned over second adhesive strip 30 to cover second adhesive strip 30.

First dividing line DL10 is positioned in folder blank 12 and extends between first body panel 16 and first pocket panel 20. First body panel 16 is connected to first pocket panel 20 along first dividing line DL10. First dividing line DL10 includes first vertical cut line VL10 and first vertical scored line VS10. First vertical cut line VL10 is connected to and in alignment with first vertical scored line VS10. Printable blank sheet 10 may include a very small hole between first vertical cut line VL10 and first vertical scored line VS10 to prevent tearing during assembly of the folder. First vertical cut line VL10 extends through printable blank sheet 10. In this embodiment, first vertical cut line VL10 is a slit-over-perforation line. In alternate embodiments, first vertical cut line VL10 may be a perforated line, die-cut line, or any other suitable cut line. First vertical scored line VS10 is a crushed scored line. Second dividing line DL12 is positioned in folder blank 12 and extends between second body panel 18 and second pocket panel 22. Second body panel 18 is connected to second pocket panel 22 along second dividing line DL12. Second dividing line DL12 includes second vertical cut line VL12 and second vertical scored line VS12. Second vertical cut line VL12 is connected to and in alignment with second vertical scored line VS12. Second vertical cut line VL12 extends through printable blank sheet 10. In this embodiment, second vertical cut line VL12 is a slit-over-perforation line. In alternate embodiments, second vertical cut line VL12 may be a perforated line, die-cut line, or any other suitable cut line. Second vertical scored line VS12 is a crushed scored line. Scored lines S are positioned on folder blank 12, and define areas where folder blank 12 can be folded from a folder blank into a folder. Scored lines S, first vertical scored line VS10, and second vertical scored line VS12 are areas where printable blank sheet 10 has been put under pressure to create a line of weakness in printable blank sheet 10 along which printable blank sheet 10 can be easily folded. Perforated lines P have perforations of any suitable weight, including micro-perforations.

Center scored line S10 extends between first body panel 16 and second body panel 18. Center scored line S10 is a crushed scored line. First body panel 16 is connected to second body panel 18 along center scored line S10. First horizontal scored line S12 extends horizontally across first pocket panel 20 from the intersection of first vertical cut line VL10, first vertical scored line VS10, and first diagonal perforated line P10 to the opposite side of first pocket panel 20. As such, first horizontal scored line S12 is connected to first vertical cut line VL10, first vertical scored line VS10, and first diagonal perforated line P10. First horizontal scored line S12 is a crushed scored line and has a length equal to dimension D1. First diagonal perforated line P10 extends diagonally across first pocket panel 20 from the intersection of first vertical cut line VL10, first vertical scored line VS10, and first horizontal scored line S12 to a bottom corner of first pocket panel 20. As such, first diagonal perforated line P10 is connected to first vertical cut line VL10, first vertical scored line VS10, and first horizontal scored line S12. First diagonal perforated line P10 extends at a 45 degree angle from first horizontal scored line S12.

Second horizontal scored line S16 extends horizontally across second pocket panel 22 from the intersection of second vertical cut line VL12, second vertical scored line VS12, and second diagonal perforated line P12 to the opposite side of second pocket panel 22. As such, second horizontal scored line S16 is connected to second vertical cut line VL12, second vertical scored line VS12, and second diagonal perforated line P12. Second horizontal scored line S16 is a crushed scored line and has a length equal to dimension D2. Second diagonal perforated line P12 extends diagonally across second pocket panel 22 from the intersection of second vertical cut line VL12, second vertical scored line VS12, and second horizontal scored line S16 to a bottom corner of second pocket panel 22. As such, second diagonal perforated line P12 is connected to second vertical cut line VL12, second vertical scored line VS12, and second horizontal scored line S16. Second diagonal perforated line P12 extends at a 45 degree angle from second horizontal scored line S16.

First tab scored line S20 extends between first body panel 16 and first tab 24. First tab scored line S20 may be a crushed scored line, a cut scored line, a tri-cut scored line, or any other suitable scored line. First tab 24 is connected to first body panel 16 along first tab scored line S20. Second tab scored lined S22 extends between second body panel 18 and second tab 26. Second tab scored line S22 may be a crushed scored line, a cut scored line, a tri-cut scored line, or any other suitable scored line. Second tab 26 is connected to second body panel 18 along second tab scored line S22.

First pocket panel 20 has first rectangular piece 20A at a top of first pocket panel 20. First rectangular piece 20A is connected to first body panel 16 along first vertical cut line VL10. First upper triangular piece 20B is connected to first rectangular piece 20A along first horizontal scored line S12. First lower triangular piece 20C is connected to first upper triangular piece 20B along first diagonal perforated line P10. First lower triangular piece 20C is connected to first body panel 16 along first vertical scored line VS10. First lower triangular piece 20C is at a bottom of first pocket panel 20.

Second pocket panel 22 has second rectangular piece 22A at a top of second pocket panel 22. Second rectangular piece 22A is connected to second body panel 18 along second vertical cut line VL12. Second upper triangular piece 22B is connected to second rectangular piece 22A along second horizontal scored line S16. Second lower triangular piece 22C is connected to second upper triangular piece 22B along second diagonal perforated line P12. Second lower triangular piece 22C is connected to second body panel 18 along second vertical scored line VS12. Second lower triangular piece 22C is at a bottom of second pocket panel 22.

First body panel 16 has sides made of center scored line S10, periphery cut line L10, first dividing line DL10, and first tab scored line S20. Second body panel 18 has sides made of center scored line S10, periphery cut line L10, second dividing line DL12, and second tab scored line S22. First pocket panel 20 has sides made of first dividing line DL10, periphery cut line L12, periphery cut line L14, and periphery cut line L16. Second pocket panel 22 has sides made of second dividing line DL12, periphery cut line L18, periphery cut line L20, and periphery cut line L22. First tab 24 has sides made of first tab scored line S20, periphery cut line L24, periphery cut line L26, and periphery cut line L28. Second tab 26 has sides made of second tab scored line S22, periphery cut line L30, periphery cut line L32, and periphery cut line L34.

First rectangular piece 20A has sides made of first vertical cut line VL10, periphery cut line L12, periphery cut line L14, and first horizontal scored line S12. First upper triangular piece 20B has sides made of first horizontal scored line S12, periphery cut line L14, and first diagonal perforated line P10. First lower triangular piece 20C has sides made of first vertical scored line VS10, first diagonal perforated line P10, and periphery cut line L16. Second rectangular piece 22A has sides made of second vertical cut line VL12, periphery cut line L18, periphery cut line L20, and second horizontal scored line S16. Second upper triangular piece 22B has sides made of second horizontal scored line S16, periphery cut line L20, and second diagonal perforated line P12. Second lower triangular piece 22C has sides made of second vertical scored line VS12, second diagonal perforated line P12, and periphery cut line L22.

Printable blank sheet 10 can be run through a printer or copier to have an image printed on it. After printing, folder blank 12 can be removed from printable blank sheet 10 by separating folder blank 12 from printable blank sheet 10 along periphery cut lines L. Folder blank 12 will then be free-standing.

When folder blank 12 has been removed from printable blank sheet 10, folder blank 12 is assembled into a folder. First pocket panel 20 can be folded about first dividing line DL10, first diagonal perforated line P10, and first horizontal scored line S12 to move first pocket panel 20 from a vertical position to a horizontal position on folder blank 12. Second pocket panel 22 can be folded about second dividing line DL12, second diagonal perforated line P12, and second horizontal scored lined S16 to move second pocket panel 22 from a vertical position to a horizontal position on folder blank 12. First adhesive cover 32 and second adhesive cover 34 can be removed to expose first adhesive strip 28 and second adhesive strip 30, respectively. First tab 24 and second tab 26 can be folded along first tab scored line S20 and second tab scored line S22 and adhered to first pocket panel 20 and second pocket panel 22, respectively. First pocket panel 20 and second pocket panel 22 form horizontal, rectangular pockets on folder blank 12. Dimensions D1 and D2 represent lengths of first pocket panel 20 and second pocket panel 22, respectively, in vertical positions and represent depths of the pockets formed by first pocket panel 20 and second pocket panel 22, respectively, in horizontal positions on folder blank 12. First body panel 16 and second body panel 18 can be folded along center scored line S10 to close the folder formed by folder blank 12.

Forming folder from folder blank 12 of printable blank sheet 10 is advantageous, as it allows a user to create custom print materials without having to order the materials from specialty print shops. This saves time and money for the user. The folder of folder blank 12 can be completely assembled from one-piece printable blank sheet 10. Further, because first pocket panel 20 and second pocket panel 22 begin in vertical positions with respect to printable blank sheet 10 and folder blank 12, printable blank sheet 10 fits in a large variety of personal printers while still being able to form folders with deep horizontal pockets as the first pocket panel 20 and the second pocket panel 22 are attached to sides of first body panel 16 and second body panel 18, respectively, and can be moved from vertical positions to horizontal positions. Because folder blank 12 has deep horizontal pockets, the folder formed by folder blank 12 is capable of enhanced securement. For example, a sheet of paper in a pocket of the folder formed by folder blank 12 is less likely to dislodge or fall out of folder blank 12. First dividing line DL10, second dividing line DL12, first horizontal scored line S12, second horizontal scored line S16, first diagonal perforated line P10, and second diagonal perforated line P12 allow for quick and easy assembly of folder blank 12.

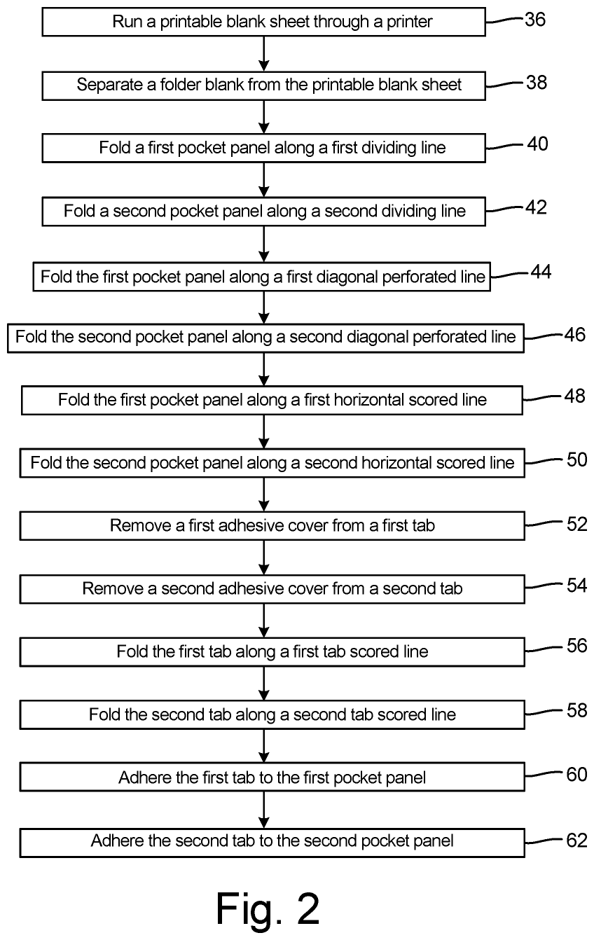

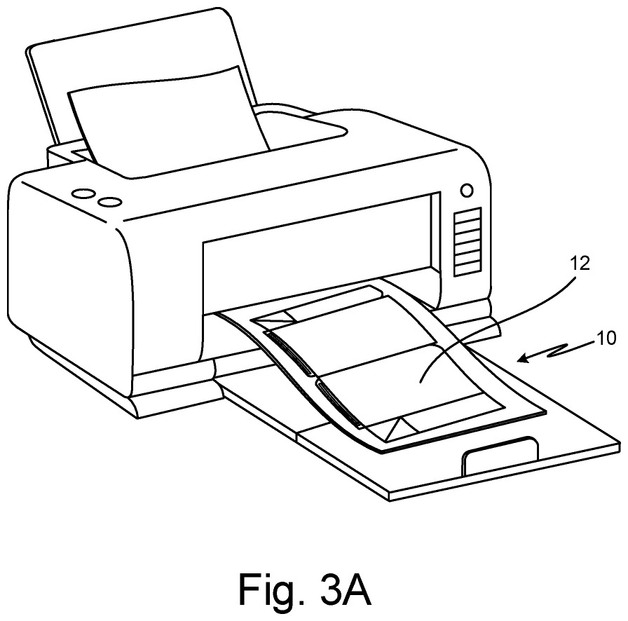

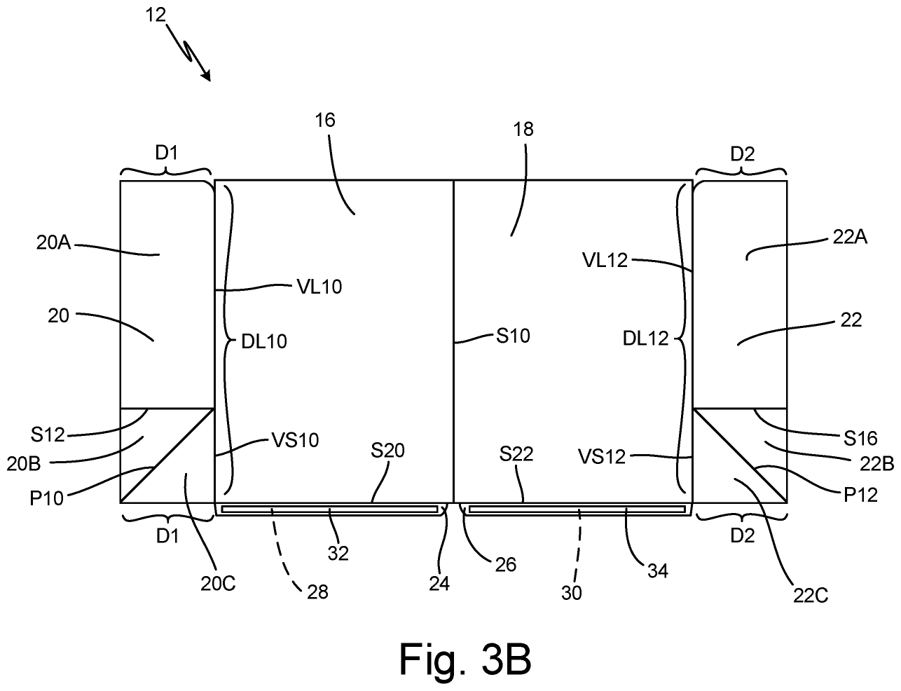

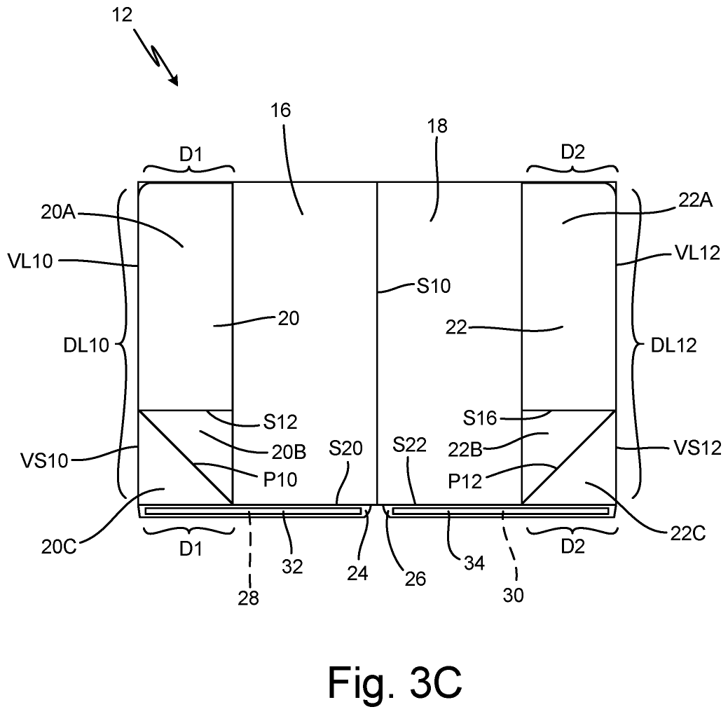

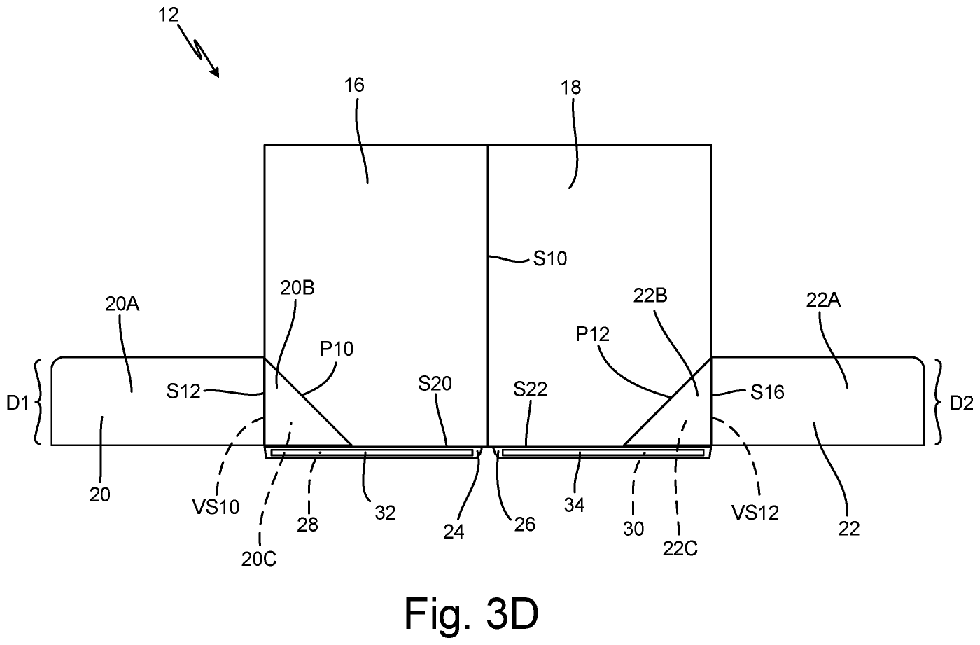

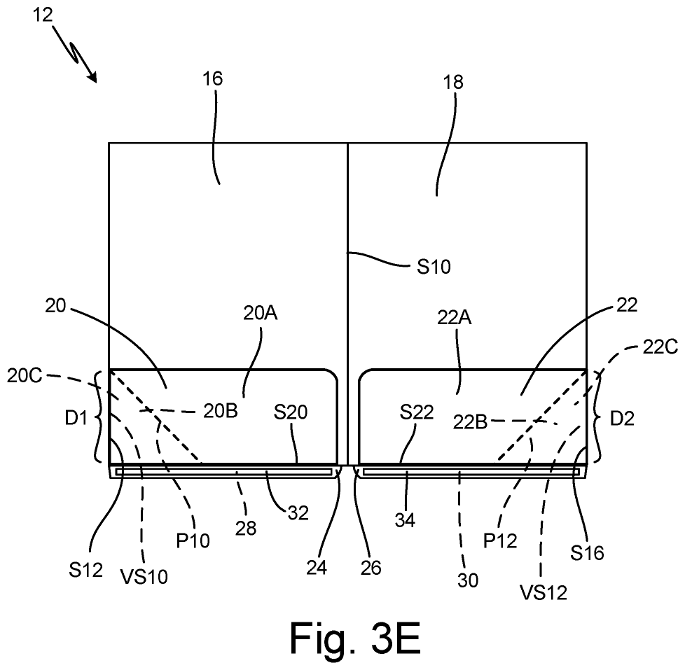

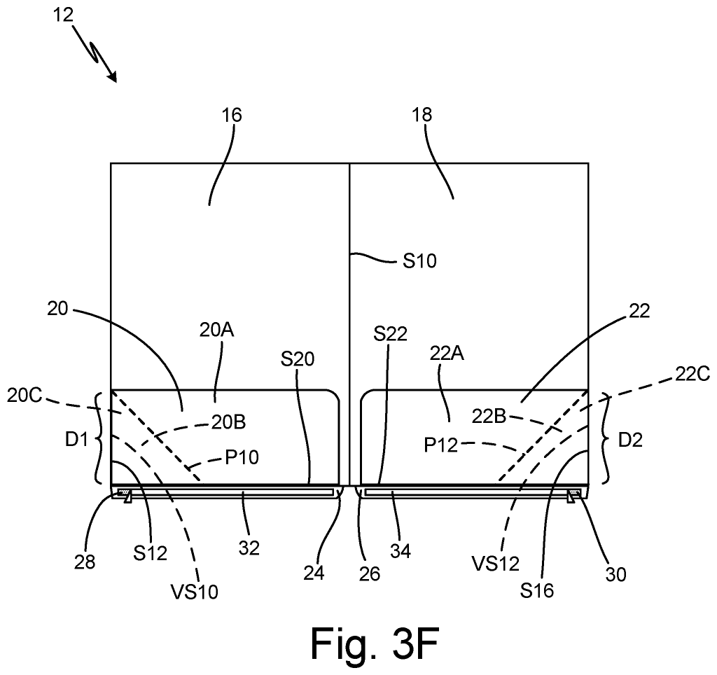

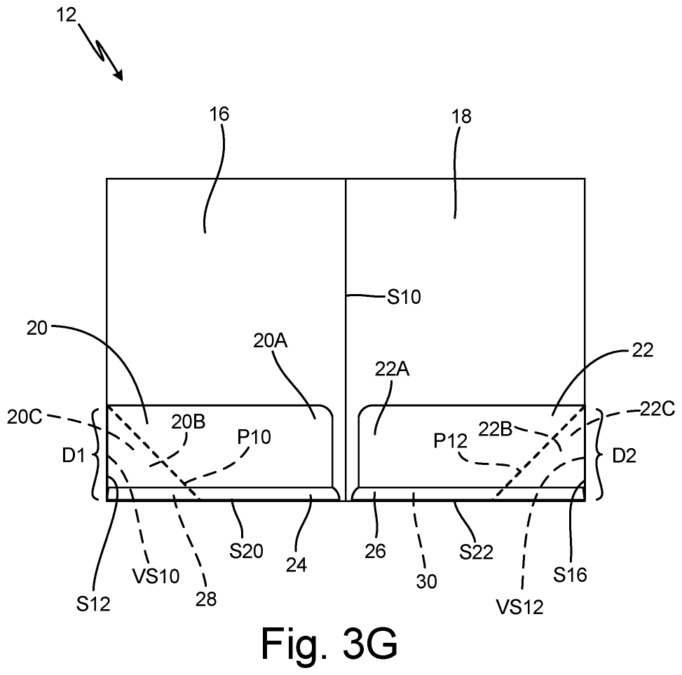

FIG. 2 is a flow chart showing a method for forming a folder from printable blank sheet 10. FIG. 2 includes steps 36, 38, 40, 42, 44, 46, 48, 50, 52, 54, 56, 58, 60, and 62 to show the method for forming a folder from printable blank sheet 10. FIGS. 3A-3G illustrate steps 36-62 shown in the flow chart of FIG. 2. FIG. 3A is a perspective view of printable blank sheet 10 as it is being run through a printer. FIG. 3B is a top plan view of folder blank 12 after it has been removed from printable blank sheet 10. FIG. 3C is a top plan view of folder blank 12 after first pocket panel 20 and second pocket panel 22 have been folded along first dividing line DL10 and second dividing line DL12, respectively. FIG. 3D is a top plan view of folder blank 12 after first pocket panel 20 and second pocket panel 22 have been folded along first diagonal perforated line P10 and second diagonal perforated line P12, respectively. FIG. 3E is a top plan view of folder blank 12 after first pocket panel 20 and second pocket panel 22 have been folded along first horizontal scored line S12 and second horizontal scored line S16, respectively. FIG. 3F is a top plan view of folder blank 12 as first adhesive cover 32 and second adhesive cover 34 are removed from first tab 24 and second tab 26, respectively. FIG. 3G is a top plan view of folder blank 12 after first tab 24 and second tab 26 have been folded along first tab scored line S20 and second tab scored line S22 and adhered to first pocket panel 20 and second pocket panel 22, respectively.

Step 36 includes running printable blank sheet 10 through a printer or copier, as shown in FIG. 3A. Printable blank sheet 10 includes folder blank 12 that is positioned in printable blank sheet 10. Printable blank sheet 10 will be supplied to a user from a manufacturer and will contain periphery cut lines L, first dividing line DL10, second dividing line DL12, first diagonal perforated line P10, second diagonal perforated line P12, and scored lines S, as shown in FIG. 1, when it is given to the user. Periphery cut lines L will define the outline of folder blank 12 in printable blank sheet 10 and will indicate separation lines. In this embodiment, both sides of printable blank sheet 10 are capable of being printed on. Prior to printing on printable blank sheet 10, a template on a computer can be used to create the custom image that is to be printed on printable blank sheet 10, and specifically folder blank 12. A user can print on both sides of first body panel 16, second body panel 18, first pocket panel 20, and second pocket panel 22 so that information is viewable to users inside and outside of the folder. In alternate embodiments, only one side of printable blank sheet 10 may be printed on. In such embodiments, first pocket panel 20 and second pocket panel 22 are positioned such that a user can print on a bottom surface of printable blank sheet 10 so that information is viewable to users on outside surfaces of first body panel 16, second body panel 18, first pocket panel 20, and second pocket panel 22 after folder blank 12 has been formed into a folder using the following method. Automatic imposition software can be used to create the design that is to be printed on printable blank sheet 10 and allows a user to create and orient the design so that it is positioned properly on folder blank 12 in printable blank sheet 10.

Step 38 includes separating folder blank 12 from printable blank sheet 10. Folder blank 12 is separated from printable blank sheet 10 along periphery cut lines L. The user can bend printable blank sheet 10 along periphery cut lines L, which define the periphery of folder blank 12 in printable blank sheet 10. In this embodiment, periphery cut lines L are slit-over perforation lines, and as printable blank sheet 10 is bent along slit-over-perforation lines, slit-over-perforation lines will snap apart. When periphery cut lines L are snapped apart, they will leave a clean edge on the portion of printable blank sheet 10 that has been separated. Bending printable blank sheet 10 along all of periphery cut lines L will break apart all periphery cut lines L and detach folder blank 12 from printable blank sheet 10. FIG. 3B shows folder blank 12 after it has been removed from printable blank sheet 10. Excess sheet area 14 can be discarded after folder blank 12 has been separated from printable blank sheet 10.

Step 40 includes folding first pocket panel 20 along first dividing line DL10, and step 42 includes folding second pocket panel 22 along second dividing line DL12. When first pocket panel 20 and second pocket panel 22 are folded along first dividing line DL10 and second dividing line DL12, first pocket panel 20 and second pocket panel 22 are folded along first vertical cut line VL10 and second vertical cut line VL12, respectively, which are slit-over-perforation lines. As a result, first vertical cut line VL10 and second vertical cut line VL12 snap apart. A portion of first pocket panel 20 and a portion of second pocket panel 22 then become separated from first body panel 16 and second body panel 18. More specifically, first rectangular piece 20A and second rectangular piece 22A become separated from first body panel 16 and second body panel 18, respectively.

First vertical scored line VS10 of first dividing line DL10 connects first pocket panel 20 to first body panel 16, and second vertical scored line VS12 of second dividing line DL12 connects second pocket panel 22 to second body panel 18. More specifically, first vertical scored line VS10 connects first lower triangular piece 20C to first body panel 16, and second vertical scored line VS12 connects second lower triangular piece 22C to second body panel 18. When first pocket panel 20 is folded along first dividing line DL10 and second pocket panel 22 is folded along second dividing line DL12, first pocket panel 20 is folded along first vertical scored line VS10 so that first pocket panel 20 overlaps first body panel 16, and second pocket panel 22 is folded along second vertical scored line VS12 so that second pocket panel 22 overlaps second body panel 18. FIG. 3C shows folder blank 12 after first pocket panel 20 and second pocket panel 22 have been folded along first dividing line DL10 and second dividing line DL12, respectively.

Step 44 includes folding first pocket panel 20 along first diagonal perforated line P10, and step 46 includes folding second pocket panel 22 along second diagonal perforated line P12. FIG. 3D shows folder blank 12 after first pocket panel 20 and second pocket panel 22 have been folded along first diagonal perforated line P10 and second diagonal perforated line P12, respectively. First diagonal perforated line P10 connects first upper triangular piece 20B to first lower triangular piece 20C, and second diagonal perforated line P12 connects second upper triangular piece 22B to second lower triangular piece 22C. As seen in FIG. 3D, first pocket panel 20 and second pocket panel 22 move from vertical positions to horizontal positons and extend away from first body panel 16 and second body panel 18 when folded about first diagonal perforated line P10 and second diagonal perforated line P12, respectively. As such, first upper triangular piece 20B overlaps first lower triangular piece 20C, and second upper triangular piece 22B overlaps second lower triangular piece 22C.

Step 48 includes folding first pocket panel 20 along first horizontal scored line S12, and step 50 includes folding second pocket panel 22 along second horizontal scored line S16. FIG. 3E shows folder blank 12 after first pocket panel 20 and second pocket panel 22 have been folded along first horizontal scored line S12 and second horizontal scored line S16, respectively. First horizontal scored line S12 connects first rectangular piece 20A to first upper triangular piece 20B, and second horizontal scored line S16 connects second rectangular piece 22A to second upper triangular piece 22B. As seen in FIG. 3E, first pocket panel 20 and second pocket panel 22 are in horizontal positions and overlap first body panel 16 and second body panel 18 when folded along first horizontal scored line S12 and second horizontal scored line S16, respectively. As such, first rectangular piece 20A overlaps first upper triangular piece 20B and first lower triangular piece 20C, and second rectangular piece 22A overlaps second upper triangular piece 22B and second lower triangular piece 22C.

Step 52 includes removing first adhesive cover 32 from first tab 24, and step 54 includes removing second adhesive cover 34 from second tab 26. First adhesive cover 32 covers first adhesive strip 28 on first tab 24, and second adhesive cover 34 covers second adhesive strip 30 on second tab 26. As shown in FIG. 3F, first adhesive cover 32 and second adhesive cover 34 can be peeled off of first adhesive strip 28 and second adhesive strip 30, respectively. As a result, first adhesive strip 28 and second adhesive strip 30 are exposed.

Step 56 includes folding first tab 24 along first tab scored line S20, and step 58 includes folding second tab 26 along second tab scored line S22. First tab scored line S20 connects first tab 24 to first body panel 16. Second tab scored line S22 connects second tab 26 to second body panel 18. When first tab 24 is folded along first tab scored line S20, first tab 24 overlaps first pocket panel 20. When second tab 26 is folded along second tab scored line S22, second tab 26 overlaps second pocket panel 22. More specifically, first tab 24 overlaps first rectangular piece 20A, and second tab 26 overlaps second rectangular piece 22A.

Step 60 includes adhering first tab 24 to first pocket panel 20, and step 62 includes adhering second tab 26 to second pocket panel 22. As first tab 24 overlaps first pocket panel 20, first pocket panel 20 comes into contact with first adhesive strip 28, adhering first tab 24 to first pocket panel 20. As second tab 26 overlaps second pocket panel 22, second pocket panel 22 comes into contact with second adhesive strip 30, adhering second tab 26 to second pocket panel 22. More specifically, first adhesive strip 28 is adhered to first rectangular piece 20A, adhering first tab 24 to first rectangular piece 20A, and second adhesive strip 30 is adhered to second rectangular piece 22A, adhering second tab 26 to second rectangular piece 22A. FIG. 3G shows folder blank 12 after first tab 24 and second tab 26 have been folded along first tab scored line S20 and second tab scored line S22 and adhered to first pocket panel 20 and second pocket panel 22, respectively. When first tab 24 is adhered to first pocket panel 20, first pocket panel 20 is secured in a horizontal position on first body panel 16. When second tab 26 is adhered to second pocket panel 22, second pocket panel 22 is secured in a horizontal position on second body panel 18. When first pocket panel 20 and second pocket panel 22 are secured in horizontal positions, first pocket panel 20 and second pocket panel 22 are pockets on folder blank 12 having depths represented by dimensions D1 and D2, respectively. First rectangular piece 20A and second rectangular piece 22A form faces of the pockets. First body panel 16 and second body panel 18 may be folded along center scored line S10 such that first body panel 16 forms a front of folder blank 12 and second body panel 18 forms a back of folder blank 12. The pockets formed by first pocket panel 20 and second pocket panel 22 are between first body panel 16 and second body panel 18 when first body panel 16 and second body panel 18 are folded along scored line S10.

The method for forming a folder from printable blank sheet 10 may include steps 36, 38, 40, 42, 44, 46, 48, 50, 52, 54, 56, 58, 60, and 62 completed in an alternative order. Folder blank 12 may be formed by folding first pocket panel 20 and second pocket panel 22 along first vertical cut line VL10, second vertical cut line VL12, first vertical scored line VS10, second vertical scored line VS12, first diagonal perforated line P10, second diagonal perforated line P12, first horizontal scored line S12, and second horizontal scored line S16 in any other suitable order or direction to move first pocket panel 20 and second pocket panel 22 from horizontal positions to vertical positions secured on folder blank 12. Additionally, first tab 24 and second tab 26 may be folded along first tab scored line S20 and second tab scored line S22 before or after folding first pocket panel 20 and second pocket panel 22. First adhesive cover 32 and second adhesive cover 34 may also be removed before or after folding first pocket panel 20 and second pocket panel 22.

The method for forming folder blank 12 is advantageous as it allows a user to easily separate and form folder blank 12 from one-piece printable blank sheet 10. Minimal effort needs to be expended on behalf of the user, as slit-over-perforation cut lines L will easily snap apart when folded. Further, separating folder blank 12 from printable blank sheet 10 along slit-over-perforation lines L will leave folder blank 12 with clean edges, which is advantageous as it presents a more polished and professional look. Additionally, because first vertical scored line VS10, second vertical scored line VS12, center scored line S10, first horizontal scored line S12, and second horizontal scored line S16 are crushed scored lines, ink is able to travel through the scored lines and appear on the folded lines of folder 12, which also presents a more polished and professional look. Minimal effort is required to fold first pocket panel 20 and second pocket panel 22 from vertical to horizontal positions with respect to folder blank 12 due to first dividing line DL10, second dividing line DL12, first horizontal scored line S12, second horizontal scored line S16, first diagonal perforated line P10, and second diagonal perforated line P12. First diagonal perforated line P10 and second diagonal perforated line P12 are particularly easy to fold because they are perforated. Further, because first pocket panel 20 and second pocket panel 22 are folded from vertical positions to horizontal positions, folder blank 12 has deep pockets for enhanced securement, and printable blank sheet comprising folder blank 12 can be used with a large variety of personal printers. As such, the method for forming folder pocket allows a user to print their own custom print materials, which saves time and money.

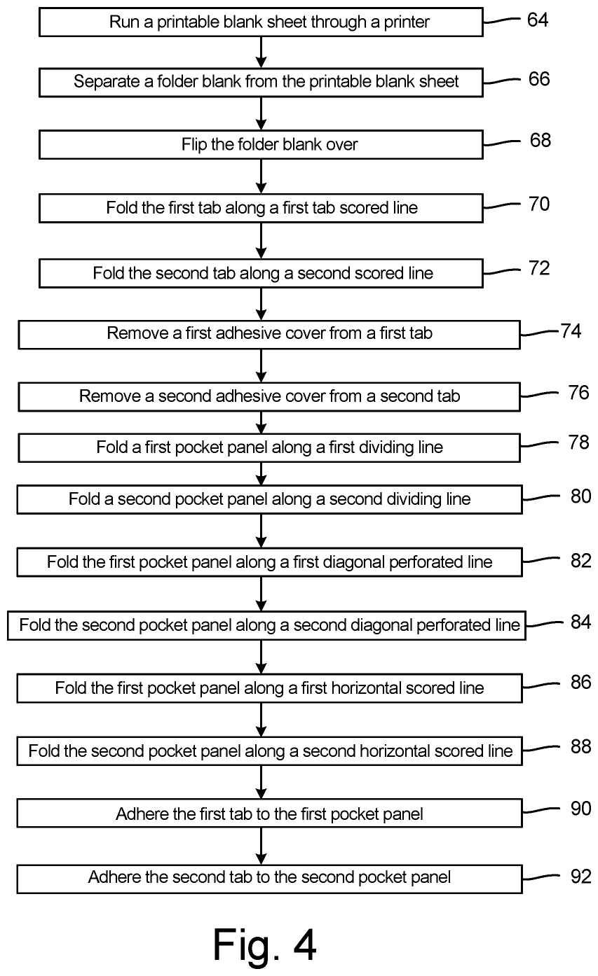

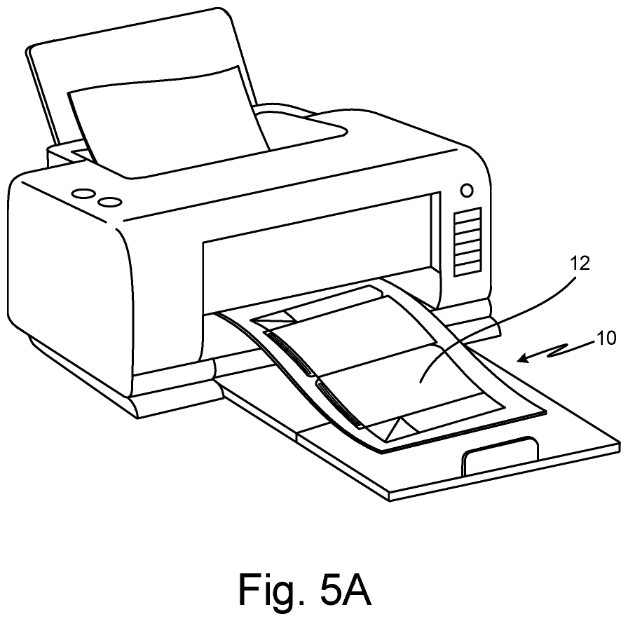

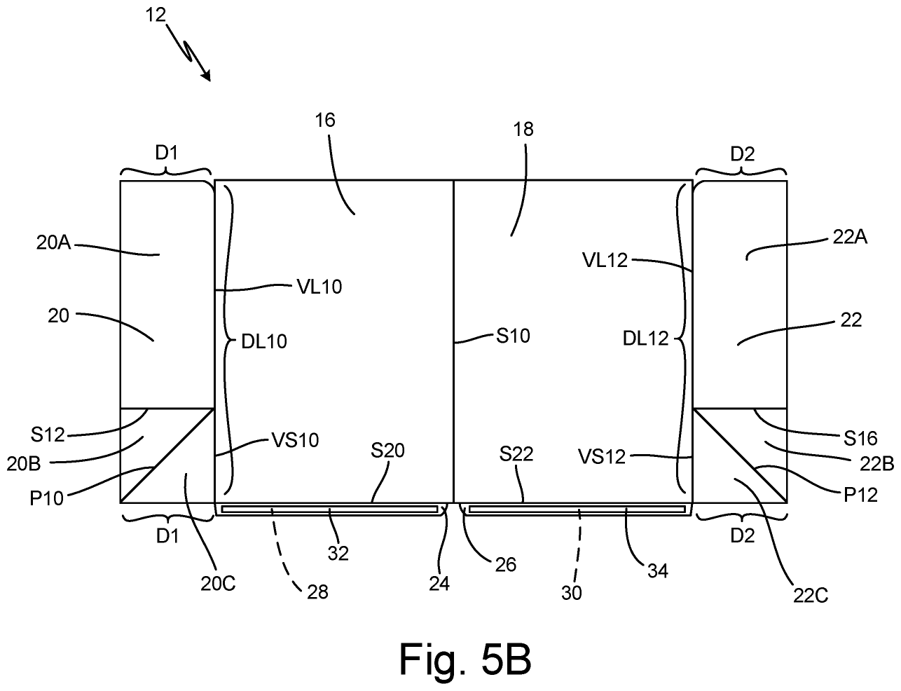

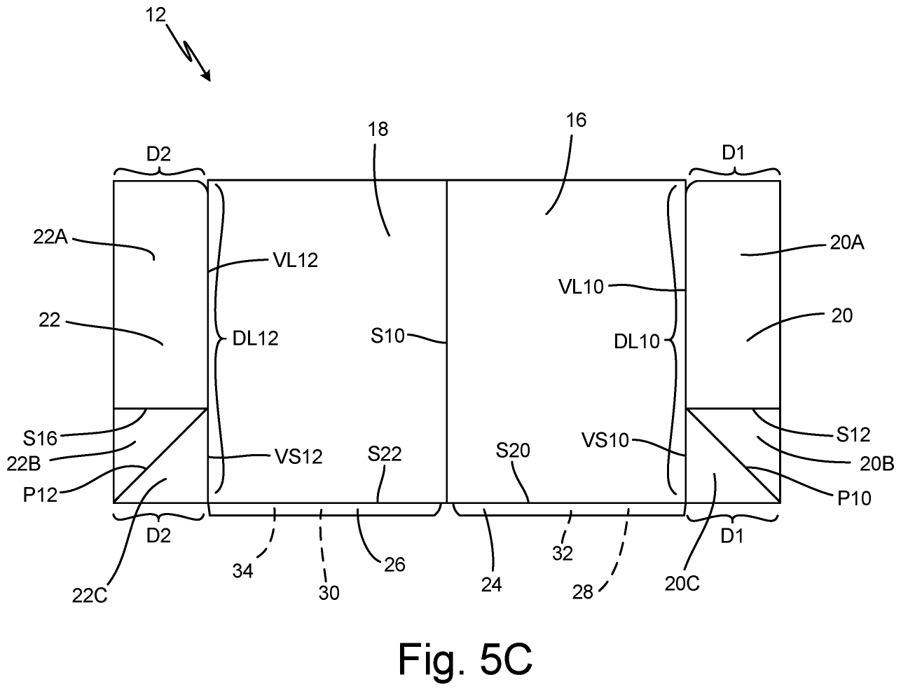

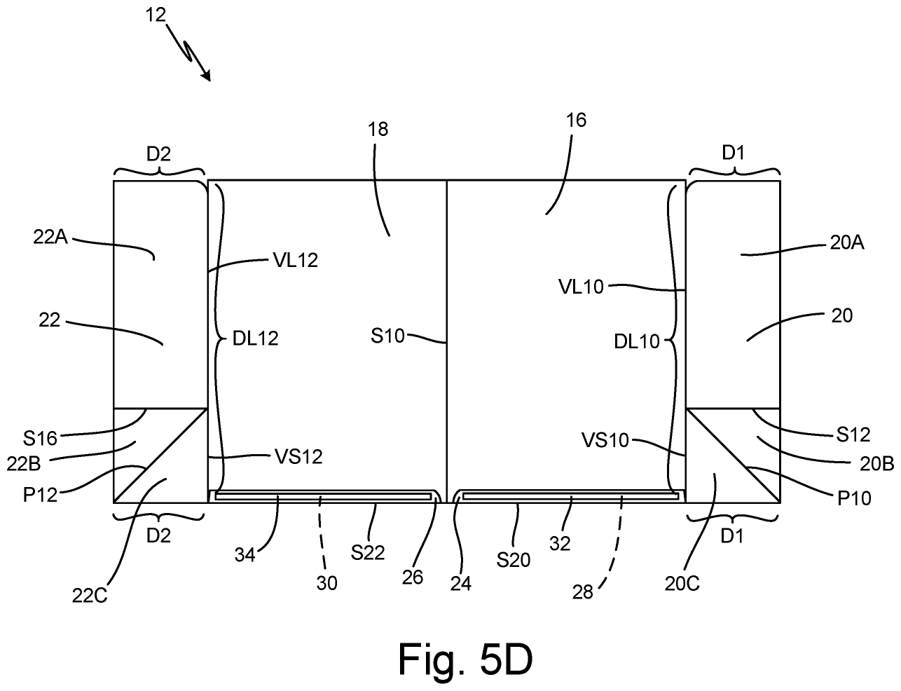

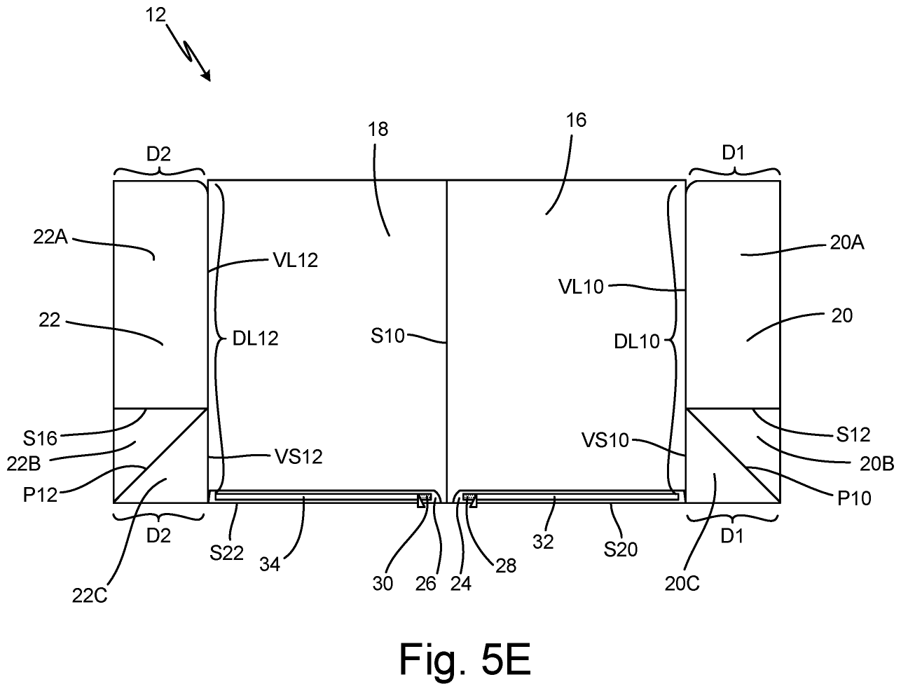

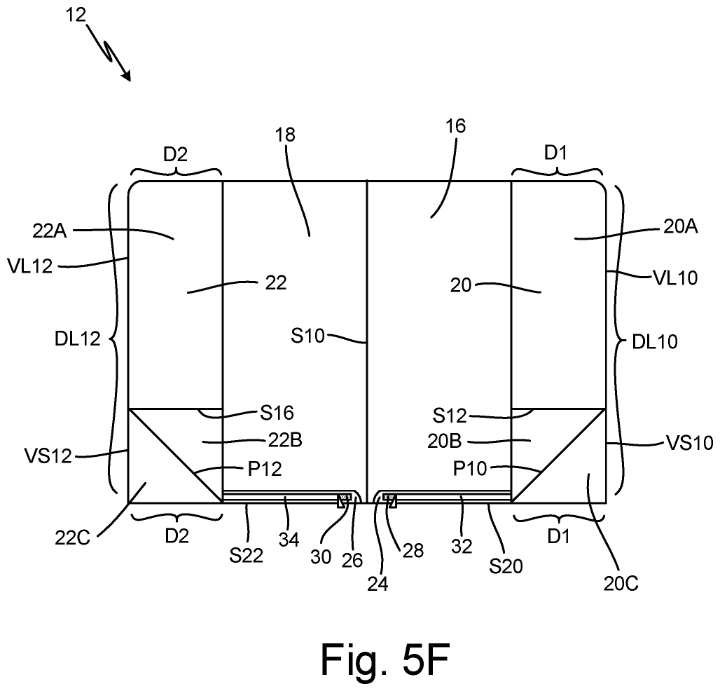

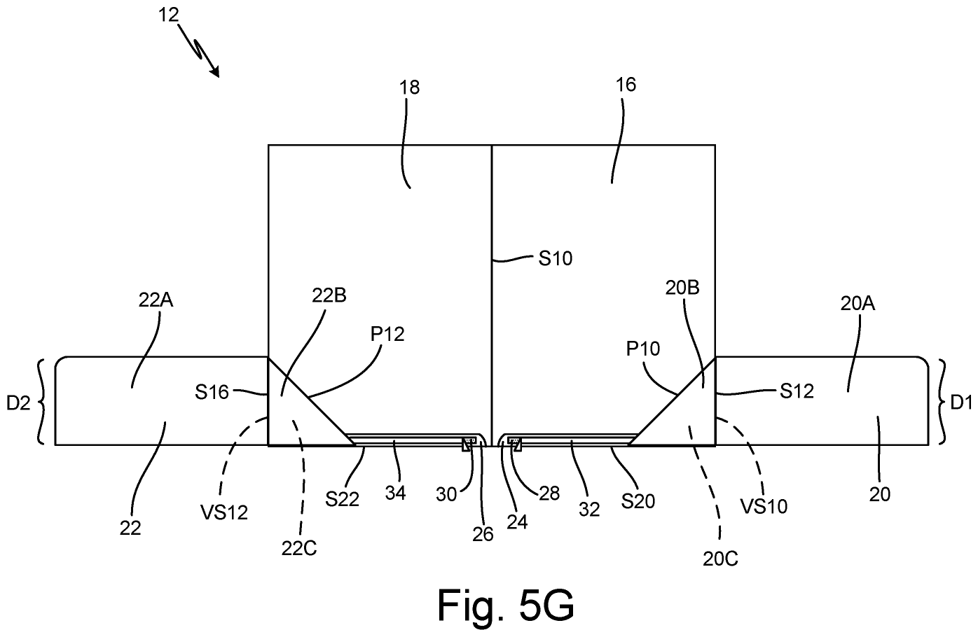

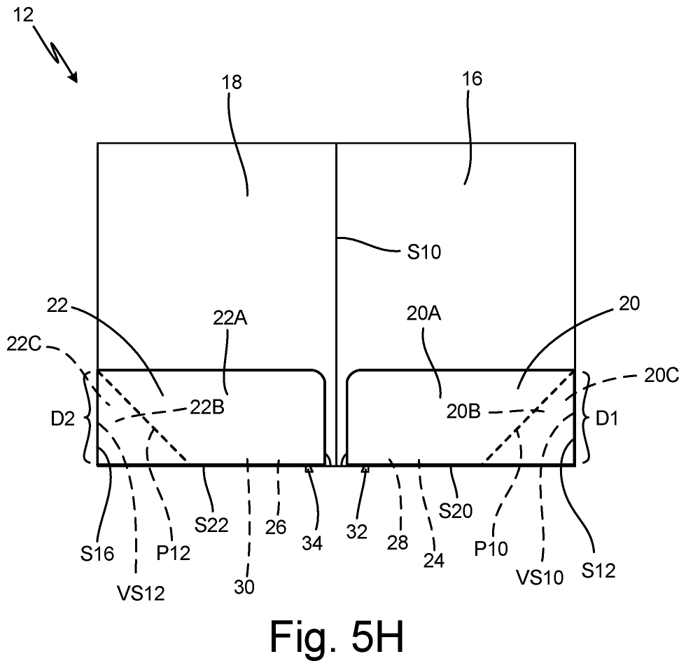

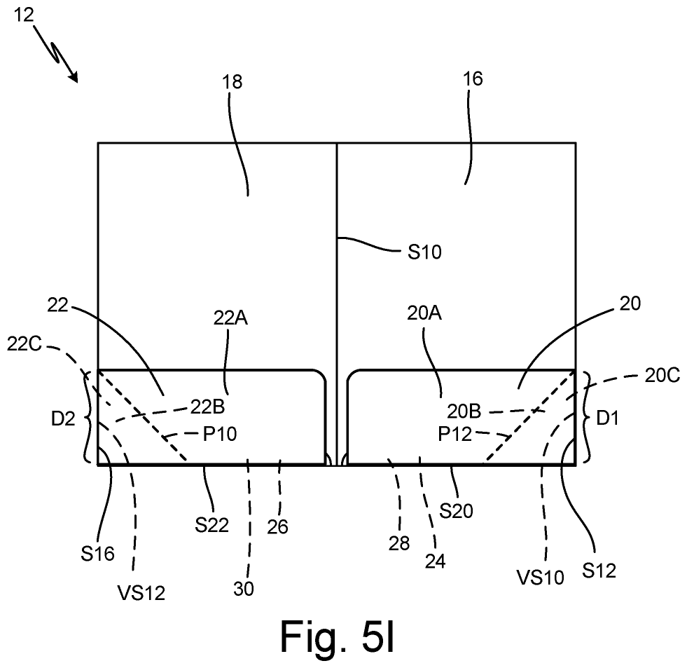

FIG. 4 is a flow chart showing an alternative method for forming a folder from printable blank sheet 10. FIG. 4 includes steps 64, 66, 68, 70, 72, 74, 76, 78, 80, 82, 84, 86, 88, 90, and 92 to show the alternative method for forming a folder from printable blank sheet 10. FIGS. 5A-5I illustrate steps 64-92 shown in the flow chart of FIG. 4. FIG. 5A is a perspective view of printable blank sheet 10 as it is being run through a printer. FIG. 5B is a top plan view of folder blank 12 after it has been removed from printable blank sheet 10. FIG. 5C is a bottom plan view of folder blank 12. FIG. 5D is a bottom plan view of folder blank 12 after first tab 24 and second tab 26 have been folded along first tab scored line S20 and second tab scored line S22. FIG. 5E is a bottom plan view of folder blank 12 as first adhesive cover 32 and second adhesive cover 34 are removed from first tab 24 and second tab 26. FIG. 5F is a bottom plan view of folder blank 12 after first pocket panel 20 and second pocket panel 22 have been folded along first dividing line DL10 and second dividing line DL 12. FIG. 5G is a bottom plan view of folder blank 12 after first pocket panel 20 and second pocket panel 22 have been folded along first diagonal perforated line P10 and second diagonal perforated line P12. FIG. 5H is a bottom plan view of folder blank 12 after first pocket panel 20 and second pocket panel 22 have been folded along first horizontal scored line S12 and second horizontal scored line S16. FIG. 5I is a bottom plan view of folder blank 12 after first tab 24 and second tab 26 have been adhered to first pocket panel 20 and second pocket panel 22.

Step 64 includes running printable blank sheet 10 through a printer or copier, as shown in FIG. 5A. Printable blank sheet 10 includes folder blank 12 that is positioned in printable blank sheet 10. Printable blank sheet 10 will be supplied to a user from a manufacturer and will contain periphery cut lines L, first dividing line DL10, second dividing line DL12, first diagonal perforated line P10, second diagonal perforated line P12, and scored lines S, as shown in FIG. 1, when it is given to the user. Periphery cut lines L will define the outline of folder blank 12 in printable blank sheet 10 and will indicate separation lines. In this embodiment, both sides of printable blank sheet 10 are capable of being printed on. Prior to printing on printable blank sheet 10, a template on a computer can be used to create the custom image that is to be printed on printable blank sheet 10, and specifically folder blank 12. A user can print on both sides of first body panel 16, second body panel 18, first pocket panel 20, and second pocket panel 22 so that information is viewable to users inside and outside of the folder. In alternate embodiments, only one side of printable blank sheet 10 may be printed on. In such embodiments, first pocket panel 20 and second pocket panel 22 are positioned such that a user can print on a top surface of printable blank sheet 10 so that information is viewable to users on outside surfaces of first body panel 16, second body panel 18, first pocket panel 20, and second pocket panel 22 after folder blank 12 has been formed into a folder using the following alternative method. Automatic imposition software can be used to create the design that is to be printed on printable blank sheet 10 and allows a user to create and orient the design so that it is positioned properly on folder blank 12 in printable blank sheet 10.

Step 66 includes separating folder blank 12 from printable blank sheet 10. Folder blank 12 is separated from printable blank sheet 10 along periphery cut lines L. The user can bend printable blank sheet 10 along periphery cut lines L, which define the periphery of folder blank 12 in printable blank sheet 10. In this embodiment, periphery cut lines L are slit-over perforation lines, and as printable blank sheet 10 is bent along slit-over-perforation lines, slit-over-perforation lines will snap apart. When periphery cut lines L are snapped apart, they will leave a clean edge on the portion of printable blank sheet 10 that has been separated. Bending printable blank sheet 10 along all of periphery cut lines L will break apart all periphery cut lines L and detach folder blank 12 from printable blank sheet 10. FIG. 5B shows folder blank 12 after it has been removed from printable blank sheet 10. Excess sheet area 14 can be discarded after folder blank 12 has been separated from printable blank sheet 10.

Step 68 includes flipping folder blank 12 over or around so that the bottom side of printable blank sheet 10 is exposed. FIG. 5C shows folder blank 12 after it has been flipped over.

Step 70 includes folding first tab 24 along first tab scored line S20, and step 72 includes folding second tab 26 along second tab scored line S22. First tab scored line S20 connects first tab 24 to first body panel 16. Second tab scored line S22 connects second tab 26 to second body panel 18. When first tab 24 is folded along first tab scored line S20, first tab 24 overlaps a bottom side of first body panel 16 such that first adhesive cover 32 is exposed. When second tab 26 is folded along second tab scored line S22, second tab 26 overlaps a bottom side of second body panel 18 such that second adhesive cover 34 is exposed. FIG. 5D shows folder blank 12 after first tab 24 and second tab 26 have been folded along first tab scored line S20 and second tab scored line S22.

Step 74 includes removing first adhesive cover 32 from first tab 24, and step 76 includes removing second adhesive cover 34 from second tab 26. First adhesive cover 32 covers first adhesive strip 28 on first tab 24, and second adhesive cover 34 covers second adhesive strip 30 on second tab 26. First adhesive cover 32 and second adhesive cover 34 can be peeled off of first adhesive strip 28 and second adhesive strip 30, respectively. As shown in FIG. 5E, first adhesive cover 32 and second adhesive cover 34 can be only partially peeled off of first adhesive strip 28 and second adhesive strip 30, respectively, such that a majority of first adhesive strip 28 and second adhesive strip 30 remain covered. As a result, first pocket panel 20 and second pocket panel 22 can be folded with proper alignment before being adhered to first tab 24 and second tab 26. The portions of first adhesive cover 32 and second adhesive cover 34 that have been peeled away form tabs that extend below first body panel 16 and second body panel 18, respectively. As a result, first adhesive strip 28 and second adhesive strip 30 are unexposed in areas adjacent first pocket panel 20 and second pocket panel 22, respectively. In alternate embodiments, the entireties of first adhesive cover 32 and second adhesive cover 34 can be peeled off to expose the entireties of first adhesive strip 28 and second adhesive strip 30.

Step 78 includes folding first pocket panel 20 along first dividing line DL10, and step 80 includes folding second pocket panel 22 along second dividing line DL12. When first pocket panel 20 and second pocket panel 22 are folded along first dividing line DL10 and second dividing line DL12, first pocket panel 20 and second pocket panel 22 are folded along first vertical cut line VL10 and second vertical cut line VL12, respectively, which are slit-over-perforation lines. As a result, first vertical cut line VL10 and second vertical cut line VL12 snap apart. A portion of first pocket panel 20 and a portion of second pocket panel 22 then become separated from first body panel 16 and second body panel 18. More specifically, first rectangular piece 20A and second rectangular piece 22A become separated from first body panel 16 and second body panel 18, respectively.

First vertical scored line VS10 of first dividing line DL10 connects first pocket panel 20 to first body panel 16, and second vertical scored line VS12 of second dividing line DL12 connects second pocket panel 22 to second body panel 18. More specifically, first vertical scored line VS10 connects first lower triangular piece 20C to first body panel 16, and second vertical scored line VS12 connects second lower triangular piece 22C to second body panel 18. When first pocket panel 20 is folded along first dividing line DL10, first pocket panel 20 is folded along first vertical scored line VS10 so that first pocket panel 20 overlaps first adhesive cover 32, first adhesive strip 28, first tab 24, and first body panel 16. When second pocket panel 22 is folded along second dividing line DL12, second pocket panel 22 is folded along second vertical scored line VS12 so that second pocket panel 22 overlaps second adhesive cover 34, second adhesive strip 30, second tab 26, and second body panel 18. As first pocket panel 20 overlaps first adhesive cover 32 and second adhesive cover 34, first pocket panel 20 and second pocket panel 22 do not contact first adhesive strip 28 and second adhesive strip 30, respectively. FIG. 5F shows folder blank 12 after first pocket panel 20 and second pocket panel 22 have been folded along first dividing line DL10 and second dividing line DL12, respectively.

Step 82 includes folding first pocket panel 20 along first diagonal perforated line P10, and step 84 includes folding second pocket panel 22 along second diagonal perforated line P12. FIG. 5G shows folder blank 12 after first pocket panel 20 and second pocket panel 22 have been folded along first diagonal perforated line P10 and second diagonal perforated line P12, respectively. First diagonal perforated line P10 connects first upper triangular piece 20B to first lower triangular piece 20C, and second diagonal perforated line P12 connects second upper triangular piece 22B to second lower triangular piece 22C. As seen in FIG. 5G, first pocket panel 20 and second pocket panel 22 move from vertical positions to horizontal positons and extend away from first body panel 16 and second body panel 18 when folded about first diagonal perforated line P10 and second diagonal perforated line P12, respectively. As such, first upper triangular piece 20B overlaps first lower triangular piece 20C, and second upper triangular piece 22B overlaps second lower triangular piece 22C.

Step 86 includes folding first pocket panel 20 along first horizontal scored line S12, and step 88 includes folding second pocket panel 22 along second horizontal scored line S16. FIG. 5H shows folder blank 12 after first pocket panel 20 and second pocket panel 22 have been folded along first horizontal scored line S12 and second horizontal scored line S16, respectively. First horizontal scored line S12 connects first rectangular piece 20A to first upper triangular piece 20B, and second horizontal scored line S16 connects second rectangular piece 22A to second upper triangular piece 22B. As seen in FIG. 5H, first pocket panel 20 and second pocket panel 22 are in horizontal positions. First pocket panel 20 overlaps first adhesive cover 32, first adhesive strip 28, first tab 24, and first body panel 16 when folded along first horizontal scored line S12. Second pocket panel 22 overlaps second adhesive cover 34, second adhesive strip 30, second tab 26, and second body panel 18 when folded along second horizontal scored line S16. As such, first rectangular piece 20A overlaps first upper triangular piece 20B, first lower triangular piece 20C, first adhesive cover 32, first adhesive strip 28, first tab 24, and first body panel 16. Second rectangular piece 22A overlaps second upper triangular piece 22B, second lower triangular piece 22C second adhesive cover 34, second adhesive strip 30, second tab 26, and second body panel 18. Further, as seen in FIG. 5H, portions or tabs of first adhesive cover 32 and second adhesive cover 34 stick out from under first pocket panel 20 and second pocket panel 22.

Step 90 includes adhering first tab 24 to first pocket panel 20, and step 92 includes adhering second tab 26 to second pocket panel 22. The portions or tabs of first adhesive cover 32 and second adhesive cover 34 that stick out from under first pocket panel 20 and second pocket panel 22 can be pulled to fully remove first adhesive cover 32 and second adhesive cover 34, respectively. As a result, first adhesive strip 28 and second adhesive strip 30 are exposed in their entirety. As first pocket panel 20 overlaps first adhesive strip 28 and first tab 24, first pocket panel 20 comes into contact with first adhesive strip 28, adhering first pocket panel 20 to first tab 24. As second pocket panel 22 overlaps second adhesive strip 30 and second tab 26, second pocket panel 22 comes into contact with second adhesive strip 30, adhering second pocket panel 22 to second tab 26. More specifically, first rectangular piece 20A and first lower triangular piece 20C are adhered to first adhesive strip 28, adhering first rectangular piece 20A and first lower triangular piece 20C to first tab 24. Second rectangular piece 22A and second lower triangular piece 22C are adhered to second adhesive strip 30, adhering second rectangular piece 22A and second lower triangular piece 22C to second tab 26.

FIG. 5I shows folder blank 12 after first adhesive strip 28 and second adhesive strip 30 have been fully removed, and first pocket panel 20 and second pocket panel 22 have been adhered to first tab 24 and second tab 26, respectively. When first tab 24 is adhered to first pocket panel 20, first pocket panel 20 is secured in a horizontal position on first body panel 16. When second tab 26 is adhered to second pocket panel 22, second pocket panel 22 is secured in a horizontal position on second body panel 18. When first pocket panel 20 and second pocket panel 22 are secured in horizontal positions, first pocket panel 20 and second pocket panel 22 are pockets on folder blank 12 having depths represented by dimensions D1 and D2, respectively. First rectangular piece 20A and second rectangular piece 22A form faces of the pockets. First body panel 16 and second body panel 18 may be folded along center scored line S10 such that second body panel 18 forms a front of folder blank 12 and first body panel 16 forms a back of folder blank 12. The pockets formed by first pocket panel 20 and second pocket panel 22 are between first body panel 16 and second body panel 18 when first body panel 16 and second body panel 18 are folded along scored line S10.

The pockets of the folder formed by this alternative method differ from the pockets of the folder formed by the first method. The faces of the pockets formed by the first method are formed by first rectangular piece 20A, second rectangular piece 22A, first tab 24, and second tab 26, as seen in FIG. 3G. The faces of the pockets formed by this alternative method are completely formed by first rectangular piece 20A and second rectangular piece 22A, as seen in FIG. 5I. First tab 24 and second tab 26 are within the respective pockets formed by this method.

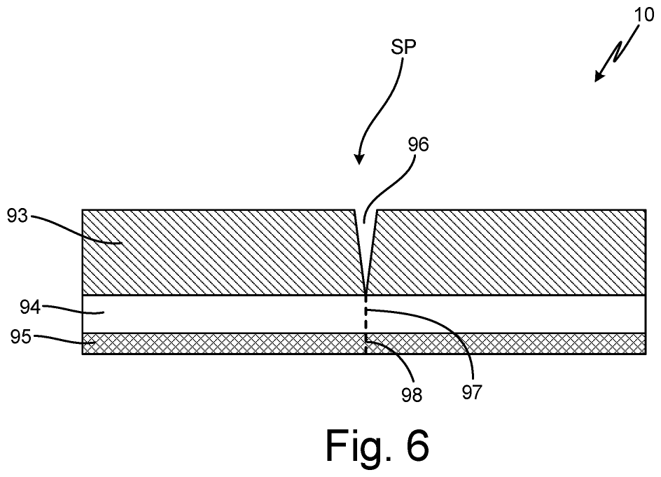

FIG. 6 is a side elevation view of slit-over-perforation line SP in printable blank sheet 10. In the embodiment of printable blank sheet 10 shown in FIGS. 1-5I, first vertical cut line VL10, second vertical cut line VL12, and periphery cut lines L, are slit-over-perforation lines SP. Printable blank sheet 10 includes sheet layer 93, laminate layer 94, and coating layer 95. Slit-over-perforation line SP includes cut 96, perforation 97, and perforation 98. Perforation 97 and perforation 98 are represented by a dashed line in FIG. 6.

Printable blank sheet 10 is made out of three layers of materials, including sheet layer 93, laminate layer 94, and coating layer 95. Sheet layer 93 is located on a top side of printable blank sheet 10. Laminate layer 94 runs through the middle of printable blank sheet 10, with sheet layer 93 on top and coating layer 95 on bottom. As such, laminate layer 94 is attached to a bottom side of sheet layer 93. Coating layer 95 is located on a bottom side of printable blank sheet 10. Sheet layer 93 and laminate layer 94 can be attached with an adhesive, or any other suitable attachment means. Coating layer 95 can be applied to a bottom side of laminate layer 94 through any suitable means. Coating layer 95 can be applied to laminate layer 94 before or after laminate layer 94 is attached to sheet layer 93. Both sheet layer 66 and coating layer 95 are capable of being printed on, thus printable blank sheet 10 can be printed on both sides. Printable blank sheet 10 can be any thickness that is capable of being passed through a printer or copier. In alternate embodiments, sheet layer 93 may be located on a bottom side of printable blank sheet 10, and coating layer 95 may be located on a top side of printable blank sheet 10. In further alternate embodiments, printable blank sheet 10 can include additional layers of materials, such as a coating layer on a top side of sheet layer 93, less layers of materials, and different layers of materials.

Sheet layer 93 can be made out of a normal sheet material that is capable of being printed on. Laminate layer 94 is made out of a laminate material that is capable of providing the strength to keep printable blank sheet 10 together as it is passed through a printer or copier. In the embodiment shown, laminate layer 94 is made out of a polyester material. Polyester materials can be used due to their high tensile strength. The tensile strength of laminate layer 94 should be high enough so that printable blank sheet 10 can be supported by laminate layer 94 as it is passed through a printer or copier. In the embodiment shown, the tensile strength of the polyester material is between 70 MPa (10,152.64 psi) and 270 MPa (39,160.18 psi). In alternate embodiments, any material having a strength that is capable of supporting printable blank sheet 10 can be used. Coating layer 95 can be made out of any material that is capable of being printed on.

Slit-over-perforation line SP includes cut 96, perforation 97, and perforation 98. Cut 96 runs through sheet layer 93 and extends from a top side of sheet layer 93 to a bottom side of sheet layer 93. Perforation 97 runs through laminate layer 94, as indicated by the dashed line in FIG. 4. Perforation 98 runs through coating layer 95, as indicated by the dashed line in FIG. 4. Cut 96, perforation 97, and perforation 98 are all aligned and run longitudinally across printable blank sheet 10. Cut 96 runs all the way through sheet layer 93 to separate sheet layer 93 along slit-over-perforation line SP. Perforation 97 and perforation 98 extend through laminate layer 94 and coating layer 95, respectively, and run underneath cut 96 along slit-over-perforation line SP. Slit-over-perforation line SP thus has a continuous cut through sheet layer 93 with cut 96 and a non-continuous cut through laminate layer 94 and coating layer 95 with perforations 72 and 74.

Slit-over-perforation lines SP, are created with a die after printable blank sheet 10 is constructed. The die has blades at a primary height and at a secondary height. Blades at the primary height have a height that is equal to the height of cut 96, perforation 97, and perforation 98 altogether. Blades at the secondary height have a height that is equal to the height of cut 96. The blades alternate with a blade at the primary height next to a blade at the secondary height next to a blade at the primary height, and so on. A die with this configuration will cut completely through sheet layer 93 at all locations but will only cut through laminate layer 94 and coating layer 95 at the locations of the blades with the primary height. The blades with the primary height will cut through laminate layer 94 and coating layer 95 in an alternating pattern due to the alternating placement of the blades. This is what creates perforations 72 and perforations 74 in laminate layer 94 and coating layer 95. Overall, a die with blades of alternating heights, such as the one described here, is capable of creating slit-over-perforation lines SP.

To create slit-over-perforation lines SP that are capable of breaking apart when bent, laminate layer 94 should have a thickness of about 0.0127 millimeters (0.0005 inches) to 0.102 millimeters (0.004 inches), and perforations 72 and perforations 74 should have a width of about 0.8 millimeters (0.0315 inches) and 2 millimeters (0.0787 inches). In the embodiment shown, laminate layer 94 has a thickness of 0.0254 millimeters (0.001 inches) and perforations 72 and perforations 74 have a width of 1.0 millimeters (0.0394 inches). In alternate embodiments, laminate layer 94 can have any thickness and perforations 72 and perforations 74 can have any width that will allow printable blank sheet 10 to break apart along slit-over-perforation lines SP when printable blank sheet 10 is bent along slit-over-perforations SP.

Slit-over-perforation lines SP run through printable blank sheet 10 to indicate where printable blank sheet 10 can be separated. Slit-over-perforation lines SP allow a user to separate printable blank sheet 10 easily, as printable blank sheet 10 can be bent along slit-over-perforation lines SP, causing perforations 72 and 74 to snap apart and separate. Separating printable blank sheet 10 along slit-over-perforation lines SP leaves a clean edge where printable blank sheet 10 is separated. There will be small microscopic marks from perforations 72 and 74, but the small microscopic marks will be unperceivable when glancing at separated edges of printable blank sheet 10.

Forming folder blank 12 from printable blank sheet 10 is advantageous, as folder blank 12 is easily separated from printable blank sheet 10 along slit-over-perforation lines SP. Slit-over-perforation lines SP are advantageous, as they allow a user to create custom print folders 12 without having to order custom print folders 12 from specialty print shops. Being able to print custom print folders 12 with clean edges allows a user to save money and time by not having to send their orders to print shops, while at the same time maintaining the quality and level of professionalism a user can get with specialty print shops.

Printable blank sheet 10 is also advantageous, as laminate layer 94 is strong enough to support printable blank sheet 10 as it is passed through a printer or copier and to prevent printable blank sheet 10 from tearing. Laminate layer 94 is constructed out of a material with a high tensile strength so that laminate layer 94 remains intact when printable blank sheet 10 is passed through a printer or copier. Perforations 72 run through laminate layer 94 to facilitate the easy separation of laminate layer 94 after printable blank sheet 10 has been printed on. The strength of laminate layer 94 is also strong enough to prevent printable blank sheet 10 from tearing.

Additionally, using laminate layer 94 with a high strength is advantageous, as it supports printable blank sheet 10 as it is passed through a printer or copier and prevents printable blank sheet 10 from tearing. Further, folder blank 12 will include laminate layer 94, which increases the strength of folder blank 12. Laminate layer 94 will make folder blank 12 stronger than previous paper structures and laminate layer 94 and coating layer 95 will make folder blank 12 moisture resistant. This allows the folder formed from folder blank 12 to be used in more settings as stronger materials can be placed in the folder, and the folder can be used in harsher environments than was previously possible.

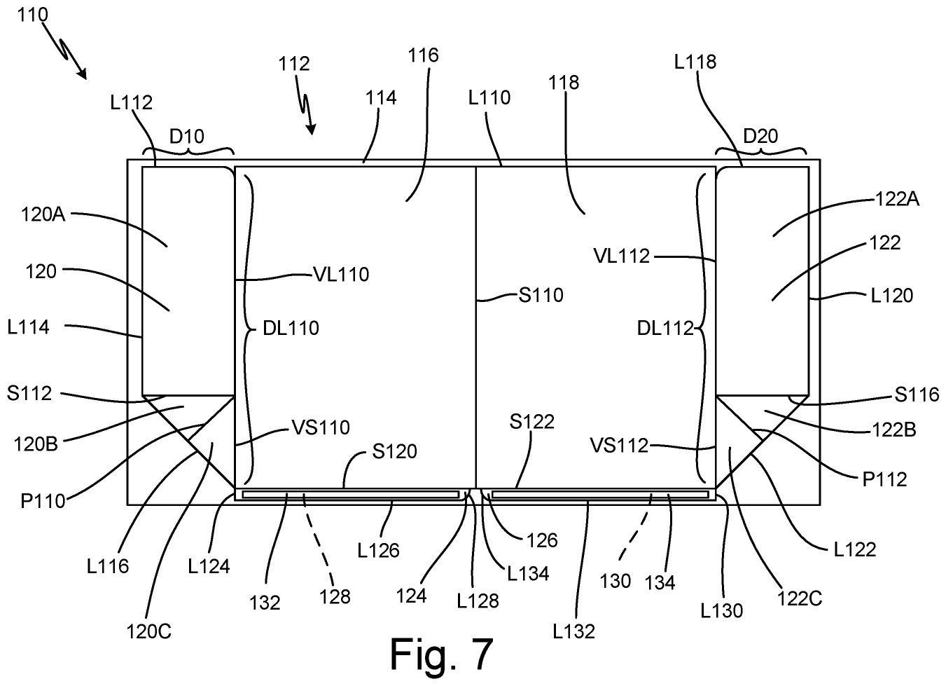

FIG. 7 is a top plan view of printable blank sheet 110 with folder blank 112. Printable blank sheet 110 includes folder blank 112, excess sheet area 114, and periphery cut lines L1 (including L110, L112, L114, L116, L118, L120, L122, L124, L126, L128, L130, L132, L134). Folder blank 112 includes first body panel 116, second body panel 118, first pocket panel 120, second pocket panel 122, first tab 124, second tab 126, first adhesive strip 128, second adhesive strip 130, first adhesive cover 132, second adhesive cover 134, first dividing line DL110 (including first vertical cut line VL110 and first vertical scored line VS110), second dividing line DL112 (including second vertical cut line VL112 and second vertical scored line VS112), scored lines S1 (including center scored line S110, first horizontal scored line S112, second horizontal scored line S116, first tab scored line S120, and second tab scored line S122), and perforated lines P1 (including first diagonal perforated line P110 and second diagonal perforated line P112). First pocket panel 120 includes first rectangular piece 120A, first upper triangular piece 120B, and first lower triangular piece 120C. Second pocket panel 122 includes second rectangular piece 122A, second upper triangular piece 122B, and second lower triangular piece 122C.

Printable blank sheet 110 is a flat sheet that is capable of being run through a printer. In this embodiment, printable blank sheet 110 includes a plurality of layers. In alternate embodiments, printable blank sheet 110 may be a single sheet. Printable blank sheet 110 may be made of uncoated paper, paper coated on one side, paper coated on both sides, material laminated on one side, material laminated on both sides, premium coated material, laminate, laminate conducive to printing, soft touch laminate, laminated leather, laminated foil, PET, premium Invercote, 80 pound digital gloss cover, 100 pound digital gloss cover, heavier stock (up to 24 point) a combination thereof, or any other suitable material or combination of materials. Folder blank 112 is positioned on, or held in, printable blank sheet 110 and is capable of being removed from printable blank sheet 110 to be assembled into a folder. Excess sheet area 114 surrounds folder blank 112 on printable blank sheet 110. After folder blank 112 has been removed from printable blank sheet 110, excess sheet area 114 can be discarded. Periphery cut lines L extend through printable blank sheet 110 and around folder blank 112 to define the periphery of folder blank 112 in printable blank sheet 110. Folder blank 112 can be removed from printable blank sheet 110 along periphery cut lines L1. In this embodiment, periphery cut lines L1 are slit-over-perforation lines SP. In alternate embodiments, periphery cut lines L1 may be perforated lines, die-cut lines, or any other suitable cut line.

Folder blank 112 has first body panel 116 with a first side connected to second body panel 118 and a second side connected to first pocket panel 120. Second body panel 118 has a first side connected to first body panel 116 and a second side connected to second pocket panel 122. As such, first body panel 116 and second body panel 118 are between first pocket panel 120 and second pocket panel 122. First pocket panel 120 and second pocket panel 122 have dimensions D10 and D20, respectively. First pocket panel 120 and second pocket panel 122 are right trapezoids and extend vertically across printable blank sheet 110, as shown in FIG. 5. Dimensions D10 and D20 represent lengths of first pocket panel 120 and second pocket panel 122, respectively, in vertical positions. In alternate embodiments, first pocket panel 120 and second pocket panel 122 may be any suitable shape. A bottom of first body panel 116 is connected to first tab 124, and a bottom of second body panel 118 is connected to second tab 126. First adhesive strip 128 is positioned on first tab 124, and second adhesive strip 130 is positioned on second tab 126. First adhesive cover 132 is positioned over first adhesive strip 128 to cover first adhesive strip 128, and second adhesive cover 134 is positioned over second adhesive strip 130 to cover second adhesive strip 130.

First dividing line DL110 is positioned in folder blank 112 and extends between first body panel 116 and first pocket panel 120. First body panel 116 is connected to first pocket panel 120 along first dividing line DL110. First dividing line DL110 includes first vertical cut line VL110 and first vertical scored line VS110. First vertical cut line VL110 is connected to and in alignment with first vertical scored line VS110. Printable blank sheet 110 may include a very small hole between first vertical cut line VL110 and first vertical scored line VS110 to prevent tearing during assembly of the folder. First vertical cut line VL110 extends through printable blank sheet 110. In this embodiment, first vertical cut line VL110 is a slit-over-perforation line SP. In alternate embodiments, first vertical cut line VL110 may be a perforated line, die-cut line, or any other suitable cut line. First vertical scored line VS110 is a crushed scored line. Second dividing line DL112 is positioned in folder blank 112 and extends between second body panel 118 and second pocket panel 122. Second body panel 118 is connected to second pocket panel 122 along second dividing line DL112. Second dividing line DL112 includes second vertical cut line VL112 and second vertical scored line VS112. Second vertical cut line VL112 is connected to and in alignment with second vertical scored line VS112. Second vertical cut line VL112 extends through printable blank sheet 110. In this embodiment, second vertical cut line VL112 is a slit-over-perforation line SP. In alternate embodiments, second vertical cut line VL112 may be a perforated line, die-cut line, or any other suitable cut line. Second vertical scored line VS112 is a crushed scored line. Scored lines 51 are positioned on folder blank 112, and define areas where folder blank 112 can be folded from a folder blank into a folder. Scored lines 51, first vertical scored line VS110, and second vertical scored line VS112 are areas where printable blank sheet 110 has been put under pressure to create a line of weakness in printable blank sheet 110 along which printable blank sheet 110 can be easily folded. Perforated lines P1 have perforations of any suitable weight, including micro-perforations.

Center scored line S110 extends between first body panel 116 and second body panel 118. Center scored line S110 is a crushed scored line. First body panel 116 is connected to second body panel 118 along center scored line S110. First horizontal scored line S112 extends horizontally across first pocket panel 120 from the intersection of first vertical cut line VL110, first vertical scored line VS110, and first diagonal perforated line P110 to the opposite side of first pocket panel 120. As such, first horizontal scored line S112 is connected to first vertical cut line VL10, first vertical scored line VS110, and first diagonal perforated line P110. First horizontal scored line S112 is a crushed scored line and has a length equal to dimension D10. First diagonal perforated line P110 extends diagonally across first pocket panel 120 from the intersection of first vertical cut line VL110, first vertical scored line VS110, and first horizontal scored line S112 to a midpoint of periphery cut line L116, which makes up a bottom side of first pocket panel 20. As such, first diagonal perforated line P110 is connected to first vertical cut line VL110, first vertical scored line VS110, and first horizontal scored line S112. First diagonal perforated line P110 extends at a 45 degree angle from first horizontal scored line S112.

Second horizontal scored line S116 extends horizontally across second pocket panel 122 from the intersection of second vertical cut line VL112, second vertical scored line VS112, and second diagonal perforated line P112 to the opposite side of second pocket panel 122. As such, second horizontal scored line S116 is connected to second vertical cut line VL112, second vertical scored line VS112, and second diagonal perforated line P112. Second horizontal scored line S116 is a crushed scored line and has a length equal to dimension D20. Second diagonal perforated line P112 extends diagonally across second pocket panel 122 from the intersection of second vertical cut line VL112, second vertical scored line VS112, and second horizontal scored line S116 to a midpoint of periphery cut line L122, which makes up a bottom side of second pocket panel 122. As such, second diagonal perforated line P112 is connected to second vertical cut line VL112, second vertical scored line VS112, and second horizontal scored line S116. Second diagonal perforated line P112 extends at a 45 degree angle from second horizontal scored line S116.

First tab scored line S120 extends between first body panel 116 and first tab 124. First tab scored line S120 may be a crushed scored line, a cut scored line, a tri-cut scored line, or any other suitable scored line. First tab 124 is connected to first body panel 116 along first tab scored line S120. Second tab scored lined S122 extends between second body panel 118 and second tab 126. Second tab scored line S122 may be a crushed scored line, a cut scored line, a tri-cut scored line, or any other suitable scored line. Second tab 126 is connected to second body panel 118 along second tab scored line S122.

First pocket panel 120 has first rectangular piece 120A at a top of first pocket panel 120. First rectangular piece 120A is connected to first body panel 116 along first vertical cut line VL110. First upper triangular piece 120B is connected to first rectangular piece 120A along first horizontal scored line S112. First lower triangular piece 120C is connected to first upper triangular piece 120B along first diagonal perforated line P110. First lower triangular piece 120C is connected to first body panel 116 along first vertical scored line VS110. First lower triangular piece 120C is at a bottom of first pocket panel 120.

Second pocket panel 122 has second rectangular piece 122A at a top of second pocket panel 122. Second rectangular piece 122A is connected to second body panel 118 along second vertical cut line VL112. Second upper triangular piece 122B is connected to second rectangular piece 122A along second horizontal scored line S116. Second lower triangular piece 122C is connected to second upper triangular piece 122B along second diagonal perforated line P112. Second lower triangular piece 122C is connected to second body panel 118 along second vertical scored line VS112. Second lower triangular piece 122C is at a bottom of second pocket panel 122.

First body panel 116 has sides made of center scored line S110, periphery cut line L110, first dividing line DL110, and first tab scored line S120. Second body panel 118 has sides made of center scored line S110, periphery cut line L110, second dividing line DL112, and second tab scored line S122. First pocket panel 120 has sides made of first dividing line DL110, periphery cut line L112, periphery cut line L114, and periphery cut line L116. Second pocket panel 122 has sides made of second dividing line DL112, periphery cut line L118, periphery cut line L120, and periphery cut line L122. First tab 124 has sides made of first tab scored line S120, periphery cut line L124, periphery cut line L126, and periphery cut line L128. Second tab 126 has sides made of second tab scored line S122, periphery cut line L130, periphery cut line L132, and periphery cut line L134.

First rectangular piece 120A has sides made of first vertical cut line VL110, periphery cut line L112, periphery cut line L114, and first horizontal scored line S112. First upper triangular piece 120B has sides made of first horizontal scored line S112, periphery cut line L116, and first diagonal perforated line P110. First lower triangular piece 120C has sides made of first vertical scored line VS110, first diagonal perforated line P110, and periphery cut line L116. Second rectangular piece 122A has sides made of second vertical cut line VL112, periphery cut line L118, periphery cut line L120, and second horizontal scored line S116. Second upper triangular piece 122B has sides made of second horizontal scored line S116, periphery cut line L122, and second diagonal perforated line P112. Second lower triangular piece 122C has sides made of second vertical scored line VS112, second diagonal perforated line P112, and periphery cut line L122.

Printable blank sheet 110 can be run through a printer or copier to have an image printed on it. After printing, folder blank 112 can be removed from printable blank sheet 110 by separating folder blank 112 from printable blank sheet 110 along periphery cut lines L1. Folder blank 112 will then be free-standing.

When folder blank 112 has been removed from printable blank sheet 110, folder blank 112 is assembled into a folder. First pocket panel 120 can be folded about first dividing line DL110, first diagonal perforated line P110, and first horizontal scored line S112 to move first pocket panel 120 from a vertical position to a horizontal position on folder blank 112. Second pocket panel 122 can be folded about second dividing line DL112, second diagonal perforated line P112, and second horizontal scored lined S116 to move second pocket panel 122 from a vertical position to a horizontal position on folder blank 112. First adhesive cover 132 and second adhesive cover 134 can be removed to expose first adhesive strip 128 and second adhesive strip 130, respectively. First tab 124 and second tab 126 can be folded along first tab scored line S120 and second tab scored line S122 and adhered to first pocket panel 120 and second pocket panel 122, respectively. First pocket panel 120 and second pocket panel 122 form horizontal, rectangular pockets on folder blank 112. Dimensions D10 and D20 represent lengths of first pocket panel 120 and second pocket panel 122, respectively, in vertical positions and represent depths of the pockets formed by first pocket panel 120 and second pocket panel 122, respectively, in horizontal positions on folder blank 112. First body panel 116 and second body panel 118 can be folded along center scored line S110 to close the folder formed by folder blank 112.

Forming folder from folder blank 112 of printable blank sheet 110 is advantageous, as it allows a user to create custom print materials without having to order the materials from specialty print shops. This saves time and money for the user. The folder of folder blank 112 can be completely assembled from one-piece printable blank sheet 110. Further, because first pocket panel 120 and second pocket panel 122 begin in vertical positions with respect to printable blank sheet 110 and folder blank 112, printable blank sheet 110 fits in a large variety of personal printers while still being able to form folders with deep horizontal pockets as the first pocket panel 120 and the second pocket panel 122 are attached to sides of first body panel 116 and second body panel 118, respectively, and can be moved from vertical positions to horizontal positions. Because folder blank 112 has deep horizontal pockets, the folder formed by folder blank 112 is capable of enhanced securement. For example, a sheet of paper in a pocket of the folder formed by folder blank 112 is less likely to dislodge or fall out of folder blank 112. First dividing line DL110, second dividing line DL112, first horizontal scored line S112, second horizontal scored line S116, first diagonal perforated line P110, and second diagonal perforated line P112 allow for quick and easy assembly of folder blank 112. The size of first upper triangular piece 120B, second upper triangular piece 122B, first lower triangular piece 120C, and second lower triangular piece 122C allow for less material, or bulk, inside the pockets.

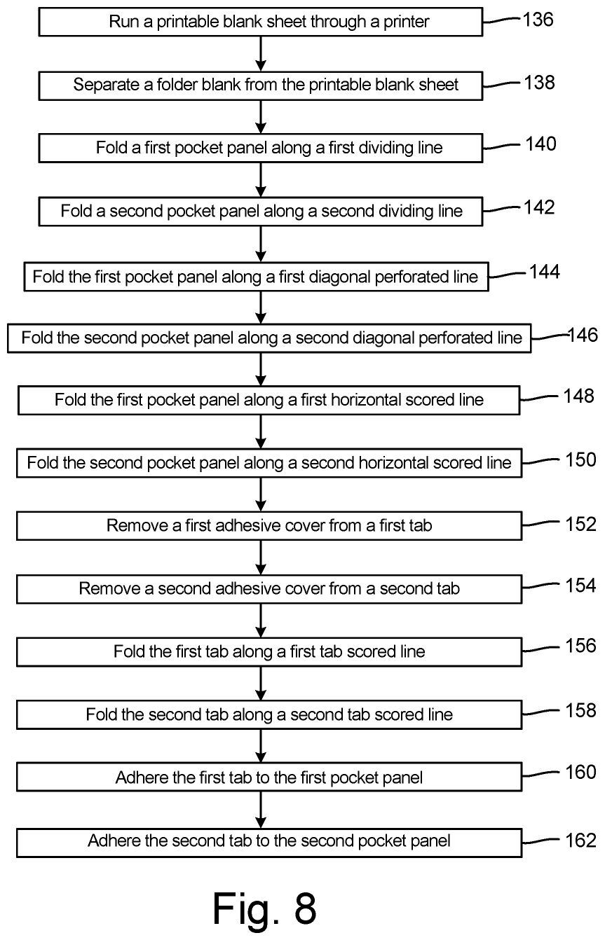

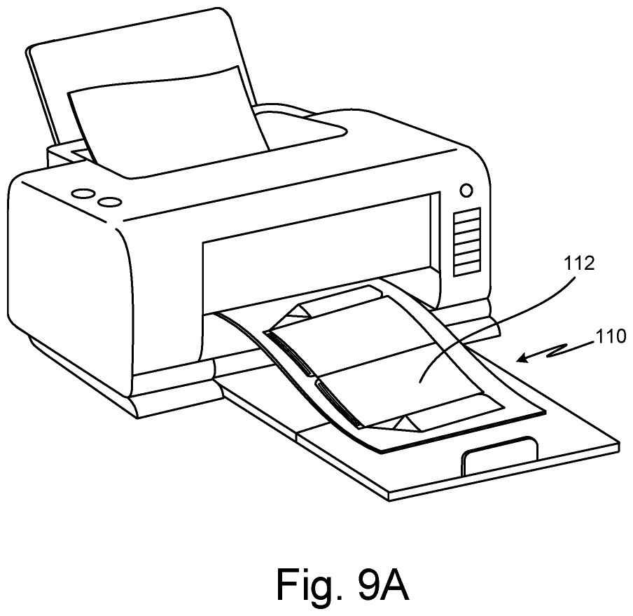

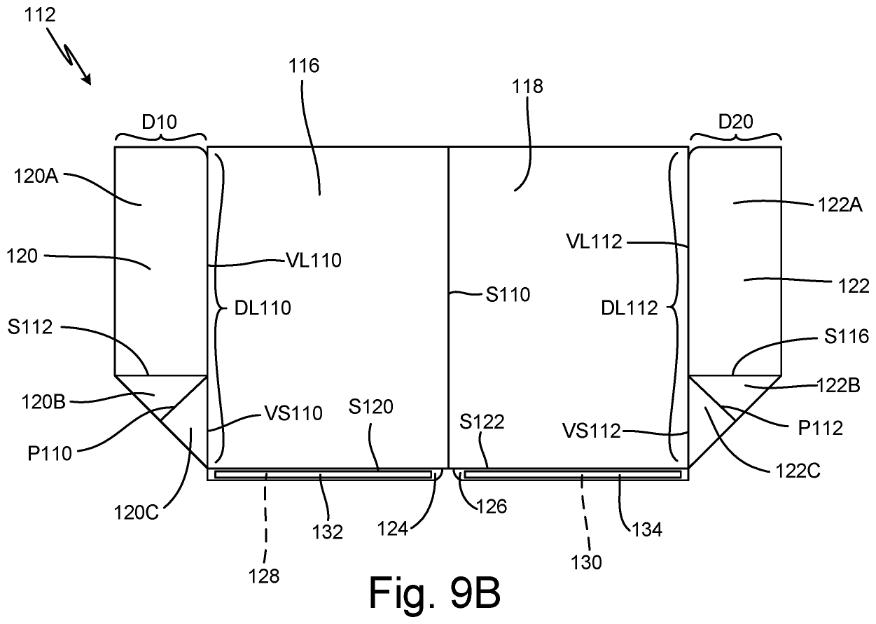

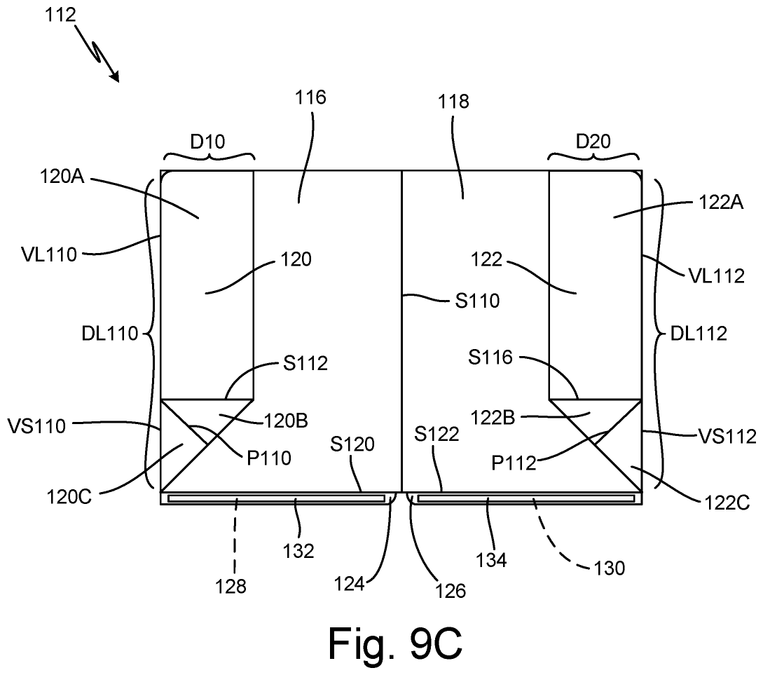

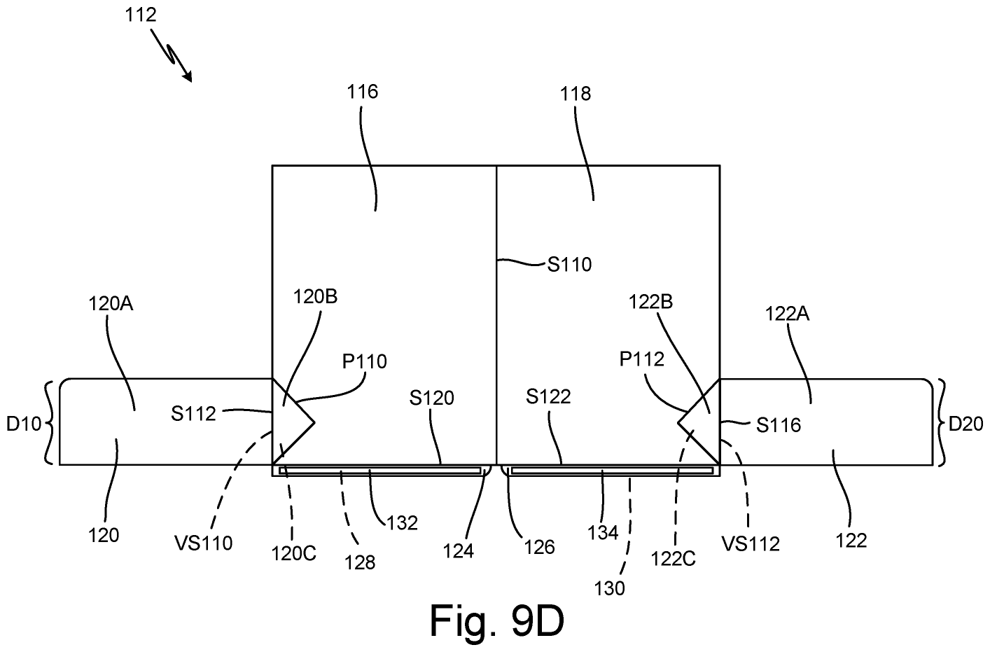

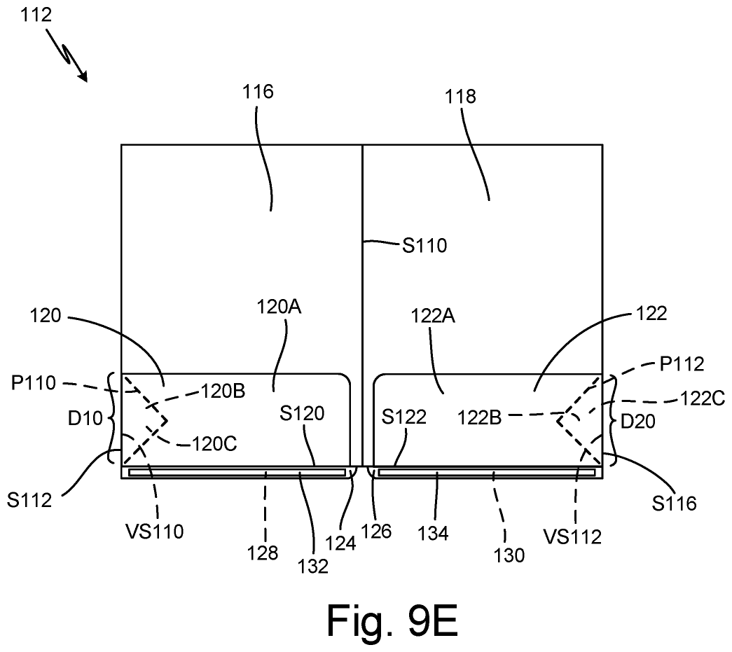

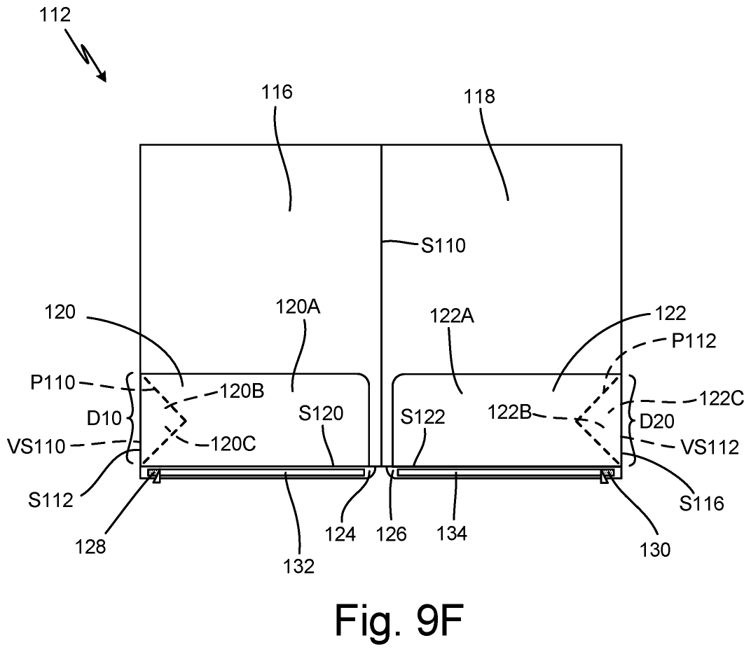

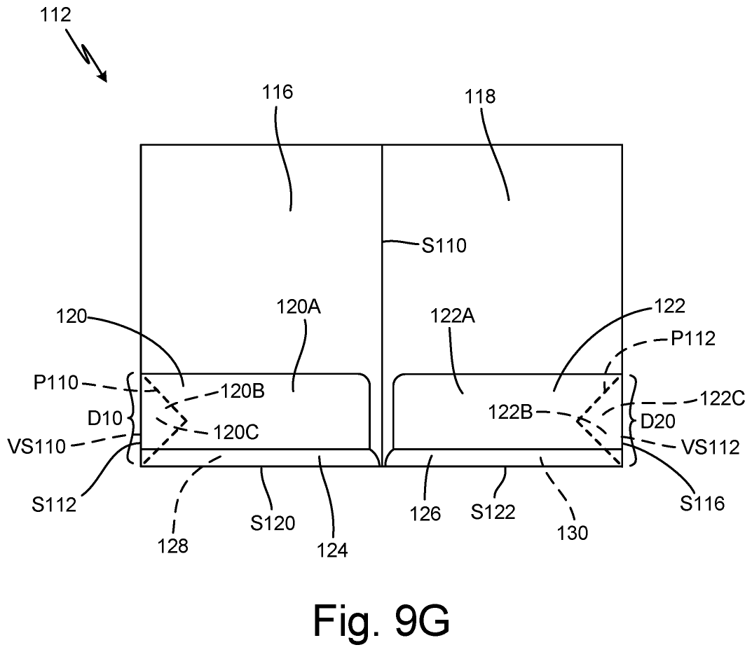

FIG. 8 is a flow chart showing a method for forming a folder from printable blank sheet 110. FIG. 8 includes steps 136, 138, 140, 142, 144, 146, 148, 150, 152, 154, 156, 158, 160, and 162 to show the method for forming a folder from printable blank sheet 110. FIGS. 9A-9G illustrate steps 136-162 shown in the flow chart of FIG. 8. FIG. 9A is a perspective view of printable blank sheet 110 as it is being run through a printer. FIG. 9B is a top plan view of folder blank 112 after it has been removed from printable blank sheet 110. FIG. 9C is a top plan view of folder blank 112 after first pocket panel 120 and second pocket panel 122 have been folded along first dividing line DL110 and second dividing line DL112, respectively. FIG. 9D is a top plan view of folder blank 112 after first pocket panel 120 and second pocket panel 122 have been folded along first diagonal perforated line P110 and second diagonal perforated line P112, respectively. FIG. 9E is a top plan view of folder blank 112 after first pocket panel 120 and second pocket panel 122 have been folded along first horizontal scored line S112 and second horizontal scored line S116, respectively. FIG. 9F is a top plan view of folder blank 112 as first adhesive cover 132 and second adhesive cover 134 are removed from first tab 124 and second tab 126, respectively. FIG. 9G is a top plan view of folder blank 112 after first tab 124 and second tab 126 have been folded along first tab scored line S120 and second tab scored line S122 and adhered to first pocket panel 120 and second pocket panel 122, respectively.

Step 136 includes running printable blank sheet 110 through a printer or copier, as shown in FIG. 9A. Printable blank sheet 110 includes folder blank 112 that is positioned in printable blank sheet 110. Printable blank sheet 110 will be supplied to a user from a manufacturer and will contain periphery cut lines L, first dividing line DL110, second dividing line DL112, first diagonal perforated line P110, second diagonal perforated line P112, and scored lines S1, as shown in FIG. 7, when it is given to the user. Periphery cut lines L1 will define the outline of folder blank 112 in printable blank sheet 110 and will indicate separation lines. In this embodiment, both sides of printable blank sheet 110 are capable of being printed on. Prior to printing on printable blank sheet 110, a template on a computer can be used to create the custom image that is to be printed on printable blank sheet 110, and specifically folder blank 112. A user can print on both sides of first body panel 116, second body panel 118, first pocket panel 120, and second pocket panel 122 so that information is viewable to users inside and outside of the folder. In alternate embodiments, only one side of printable blank sheet 110 may be printed on. In such embodiments, first pocket panel 120 and second pocket panel 122 are positioned such that a user can print on a bottom surface of printable blank sheet 110 so that information is viewable to users on outside surfaces of first body panel 116, second body panel 118, first pocket panel 120, and second pocket panel 122 after folder blank 112 has been formed into a folder using the following method. Automatic imposition software can be used to create the design that is to be printed on printable blank sheet 110 and allows a user to create and orient the design so that it is positioned properly on folder blank 112 in printable blank sheet 110.

Step 138 includes separating folder blank 112 from printable blank sheet 110. Folder blank 112 is separated from printable blank sheet 110 along periphery cut lines L1. The user can bend printable blank sheet 110 along periphery cut lines L1, which define the periphery of folder blank 112 in printable blank sheet 110. In this embodiment, periphery cut lines L1 are slit-over perforation lines SP, as shown in FIG. 6, and as printable blank sheet 110 is bent along slit-over-perforation lines SP, slit-over-perforation lines SP will snap apart. When periphery cut lines L1 are snapped apart, they will leave a clean edge on the portion of printable blank sheet 110 that has been separated. Bending printable blank sheet 110 along all of periphery cut lines L1 will break apart all periphery cut lines L1 and detach folder blank 112 from printable blank sheet 110. FIG. 9B shows folder blank 112 after it has been removed from printable blank sheet 110. Excess sheet area 114 can be discarded after folder blank 112 has been separated from printable blank sheet 110.

Step 140 includes folding first pocket panel 120 along first dividing line DL110, and step 142 includes folding second pocket panel 122 along second dividing line DL112. When first pocket panel 120 and second pocket panel 122 are folded along first dividing line DL110 and second dividing line DL112, first pocket panel 120 and second pocket panel 122 are folded along first vertical cut line VL110 and second vertical cut line VL112, respectively, which are slit-over-perforation lines SP. As a result, first vertical cut line VL110 and second vertical cut line VL112 snap apart. A portion of first pocket panel 120 and a portion of second pocket panel 122 then become separated from first body panel 116 and second body panel 118. More specifically, first rectangular piece 120A and second rectangular piece 122A become separated from first body panel 116 and second body panel 118, respectively.

First vertical scored line VS110 of first dividing line DL110 connects first pocket panel 120 to first body panel 116, and second vertical scored line VS112 of second dividing line DL112 connects second pocket panel 122 to second body panel 118. More specifically, first vertical scored line VS110 connects first lower triangular piece 120C to first body panel 116, and second vertical scored line VS112 connects second lower triangular piece 122C to second body panel 118. When first pocket panel 120 is folded along first dividing line DL110 and second pocket panel 122 is folded along second dividing line DL112, first pocket panel 120 is folded along first vertical scored line VS110 so that first pocket panel 120 overlaps first body panel 116, and second pocket panel 122 is folded along second vertical scored line VS112 so that second pocket panel 122 overlaps second body panel 118. FIG. 9C shows folder blank 112 after first pocket panel 120 and second pocket panel 122 have been folded along first dividing line DL110 and second dividing line DL112, respectively.

Step 144 includes folding first pocket panel 120 along first diagonal perforated line P110, and step 146 includes folding second pocket panel 122 along second diagonal perforated line P112. FIG. 9D shows folder blank 112 after first pocket panel 120 and second pocket panel 122 have been folded along first diagonal perforated line P110 and second diagonal perforated line P112, respectively. First diagonal perforated line P110 connects first upper triangular piece 120B to first lower triangular piece 120C, and second diagonal perforated line P112 connects second upper triangular piece 122B to second lower triangular piece 122C. As seen in FIG. 9D, first pocket panel 120 and second pocket panel 122 move from vertical positions to horizontal positons and extend away from first body panel 116 and second body panel 118 when folded about first diagonal perforated line P110 and second diagonal perforated line P112, respectively. As such, first upper triangular piece 120B overlaps first lower triangular piece 120C, and second upper triangular piece 122B overlaps second lower triangular piece 122C.

Step 148 includes folding first pocket panel 120 along first horizontal scored line S112, and step 150 includes folding second pocket panel 122 along second horizontal scored line S116. FIG. 9E shows folder blank 112 after first pocket panel 120 and second pocket panel 122 have been folded along first horizontal scored line S112 and second horizontal scored line S116, respectively. First horizontal scored line S112 connects first rectangular piece 120A to first upper triangular piece 120B, and second horizontal scored line S116 connects second rectangular piece 122A to second upper triangular piece 122B. As seen in FIG. 9E, first pocket panel 120 and second pocket panel 122 are in horizontal positions and overlap first body panel 116 and second body panel 118 when folded along first horizontal scored line S112 and second horizontal scored line S116, respectively. As such, first rectangular piece 120A overlaps first upper triangular piece 120B and first lower triangular piece 120C, and second rectangular piece 122A overlaps second upper triangular piece 122B and second lower triangular piece 122C.

Step 152 includes removing first adhesive cover 132 from first tab 124, and step 154 includes removing second adhesive cover 134 from second tab 126. First adhesive cover 132 covers first adhesive strip 128 on first tab 124, and second adhesive cover 134 covers second adhesive strip 130 on second tab 126. As shown in FIG. 9F, first adhesive cover 132 and second adhesive cover 134 can be peeled off of first adhesive strip 128 and second adhesive strip 130, respectively. As a result, first adhesive strip 128 and second adhesive strip 130 are exposed.

Step 156 includes folding first tab 124 along first tab scored line S120, and step 158 includes folding second tab 126 along second tab scored line S122. First tab scored line S120 connects first tab 124 to first body panel 116. Second tab scored line S122 connects second tab 126 to second body panel 118. When first tab 124 is folded along first tab scored line S120, first tab 124 overlaps first pocket panel 120. When second tab 126 is folded along second tab scored line S122, second tab 126 overlaps second pocket panel 122. More specifically, first tab 124 overlaps first rectangular piece 120A, and second tab 126 overlaps second rectangular piece 122A.

Step 160 includes adhering first tab 124 to first pocket panel 120, and step 162 includes adhering second tab 126 to second pocket panel 122. As first tab 124 overlaps first pocket panel 120, first pocket panel 120 comes into contact with first adhesive strip 128, adhering first tab 124 to first pocket panel 120. As second tab 126 overlaps second pocket panel 122, second pocket panel 122 comes into contact with second adhesive strip 130, adhering second tab 126 to second pocket panel 122. More specifically, first adhesive strip 128 is adhered to first rectangular piece 120A, adhering first tab 124 to first rectangular piece 120A, and second adhesive strip 130 is adhered to second rectangular piece 122A, adhering second tab 126 to second rectangular piece 122A. FIG. 9G shows folder blank 112 after first tab 124 and second tab 126 have been folded along first tab scored line S120 and second tab scored line S122 and adhered to first pocket panel 120 and second pocket panel 122, respectively. When first tab 124 is adhered to first pocket panel 120, first pocket panel 120 is secured in a horizontal position on first body panel 116. When second tab 126 is adhered to second pocket panel 122, second pocket panel 122 is secured in a horizontal position on second body panel 118. When first pocket panel 120 and second pocket panel 122 are secured in horizontal positions, first pocket panel 120 and second pocket panel 122 are pockets on folder blank 112 having depths represented by dimensions D10 and D20, respectively. First rectangular piece 120A and second rectangular piece 122A form faces of the pockets. First body panel 116 and second body panel 118 may be folded along center scored line S110 such that first body panel 116 forms a front of folder blank 112 and second body panel 118 forms a back of folder blank 112. The pockets formed by first pocket panel 120 and second pocket panel 122 are between first body panel 116 and second body panel 118 when first body panel 116 and second body panel 118 are folded along scored line S110.

The method for forming a folder from printable blank sheet 110 may include steps 136, 138, 140, 142, 144, 146, 148, 150, 152, 154, 156, 158, 160, and 162 completed in an alternative order. Folder blank 112 may be formed by folding first pocket panel 120 and second pocket panel 122 along first vertical cut line VL110, second vertical cut line VL112, first vertical scored line VS110, second vertical scored line VS112, first diagonal perforated line P110, second diagonal perforated line P112, first horizontal scored line S112, and second horizontal scored line S116 in any other suitable order or direction to move first pocket panel 120 and second pocket panel 122 from horizontal positions to vertical positions secured on folder blank 112. Additionally, first tab 124 and second tab 126 may be folded along first tab scored line S120 and second tab scored line S122 before or after folding first pocket panel 120 and second pocket panel 122. First adhesive cover 132 and second adhesive cover 134 may also be removed before or after folding first pocket panel 120 and second pocket panel 122.

The method for forming folder blank 112 is advantageous as it allows a user to easily separate and form folder blank 112 from one-piece printable blank sheet 110. Minimal effort needs to be expended on behalf of the user, as slit-over-perforation cut lines L will easily snap apart when folded. Further, separating folder blank 112 from printable blank sheet 110 along slit-over-perforation lines SP will leave folder blank 112 with clean edges, which is advantageous as it presents a more polished and professional look. Additionally, because first vertical scored line VS110, second vertical scored line VS112, center scored line S110, first horizontal scored line S112, and second horizontal scored line S116 are crushed scored lines, ink is able to travel through the scored lines and appear on the folded lines of folder 112, which also presents a more polished and professional look. Minimal effort is required to fold first pocket panel 120 and second pocket panel 122 from vertical to horizontal positions with respect to folder blank 112 due to first dividing line DL110, second dividing line DL112, first horizontal scored line S112, second horizontal scored line S116, first diagonal perforated line P110, and second diagonal perforated line P112. First diagonal perforated line P110 and second diagonal perforated line P112 are particularly easy to fold because they are perforated. Further, because first pocket panel 120 and second pocket panel 122 are folded from vertical positions to horizontal positions, folder blank 112 has deep pockets for enhanced securement, and printable blank sheet comprising folder blank 112 can be used with a large variety of personal printers. As such, the method for forming folder pocket allows a user to print their own custom print materials, which saves time and money.

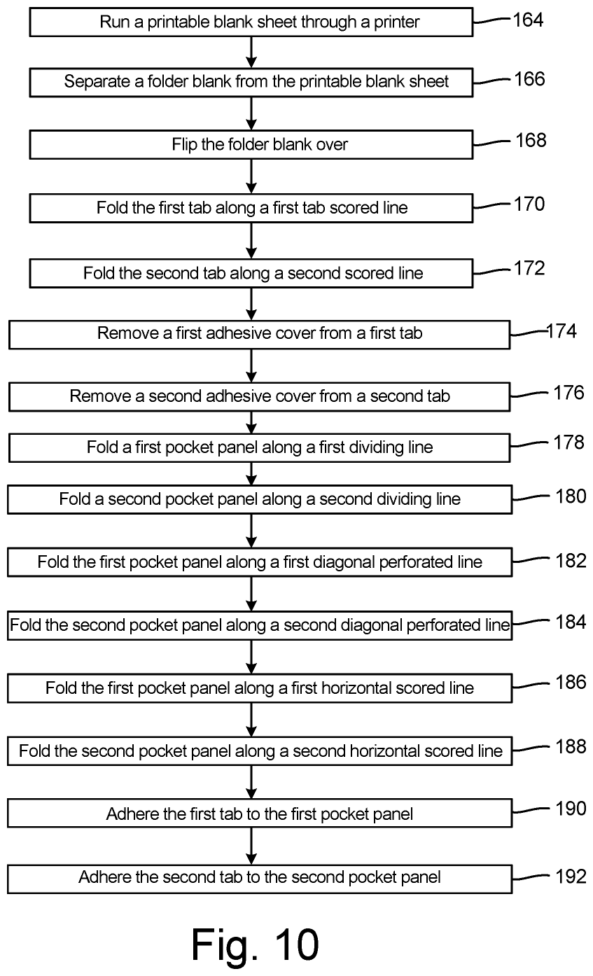

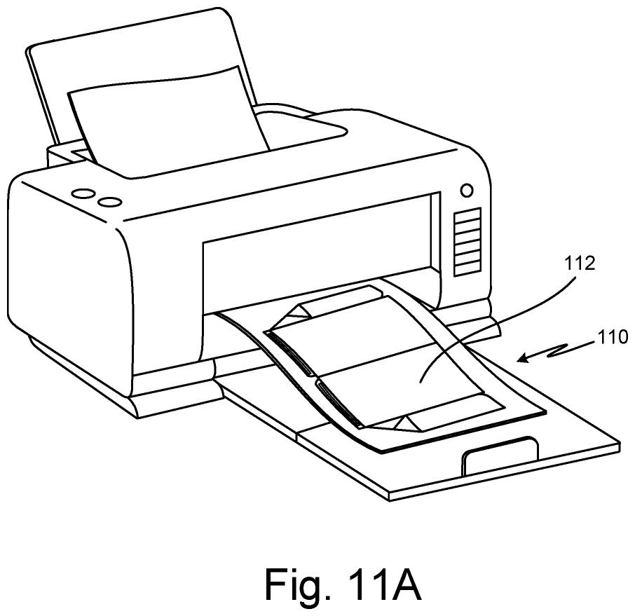

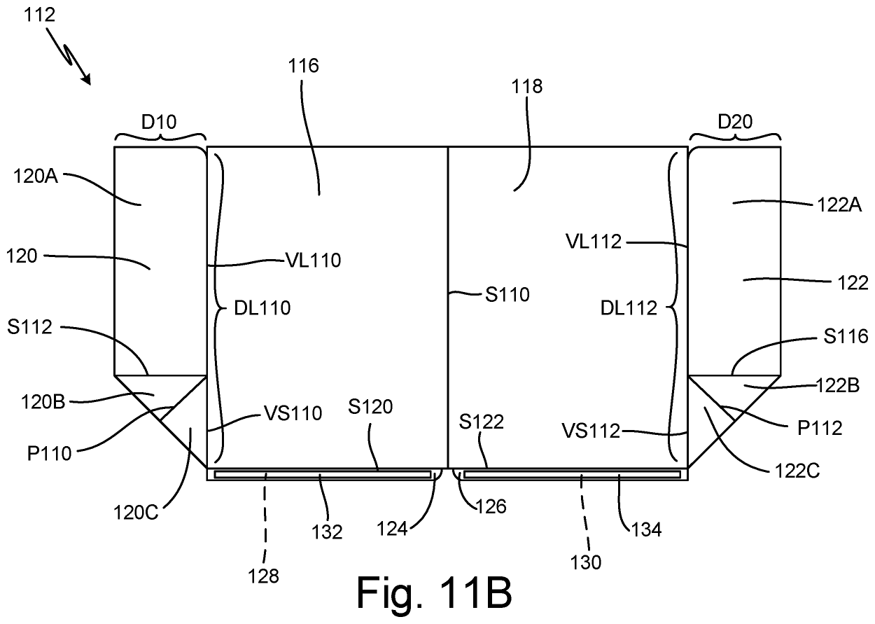

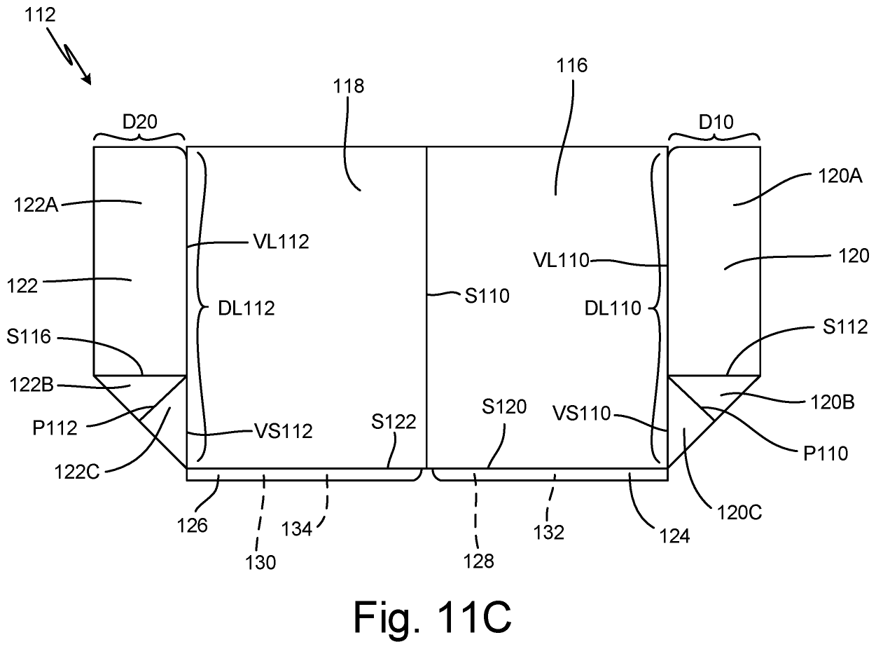

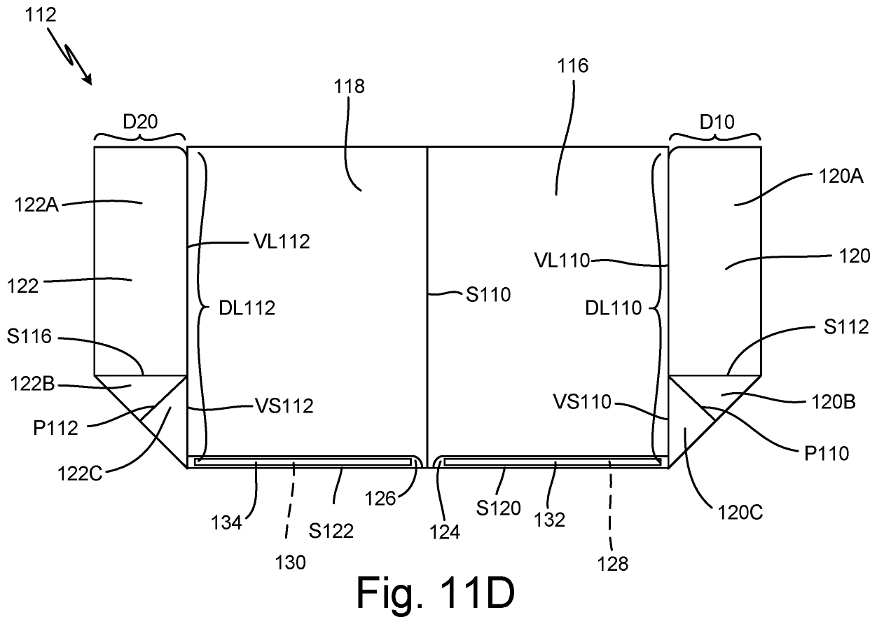

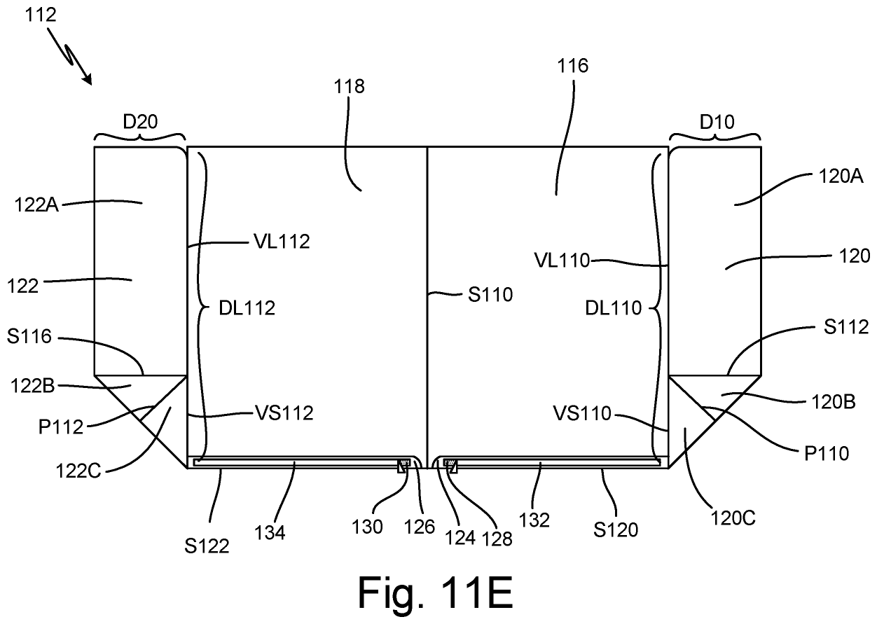

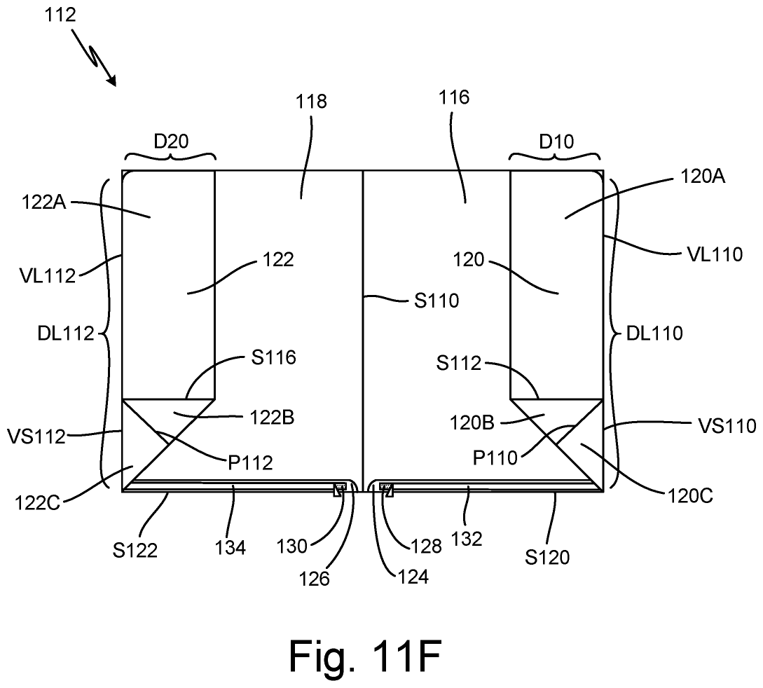

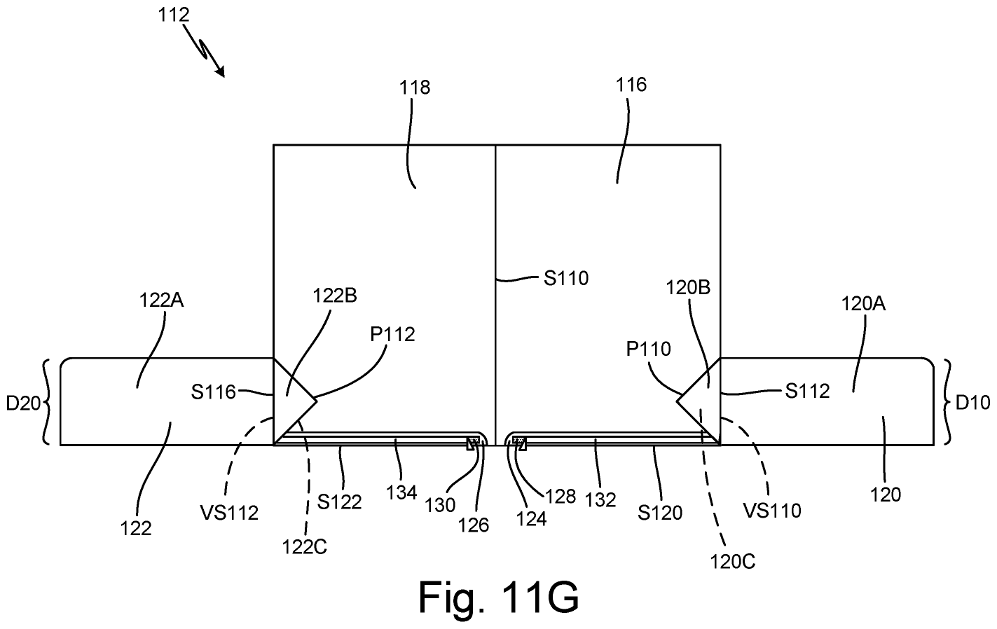

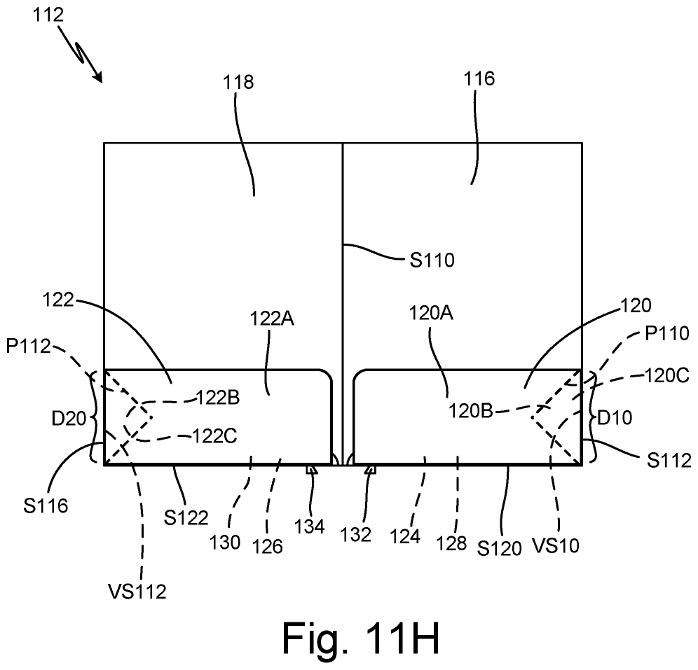

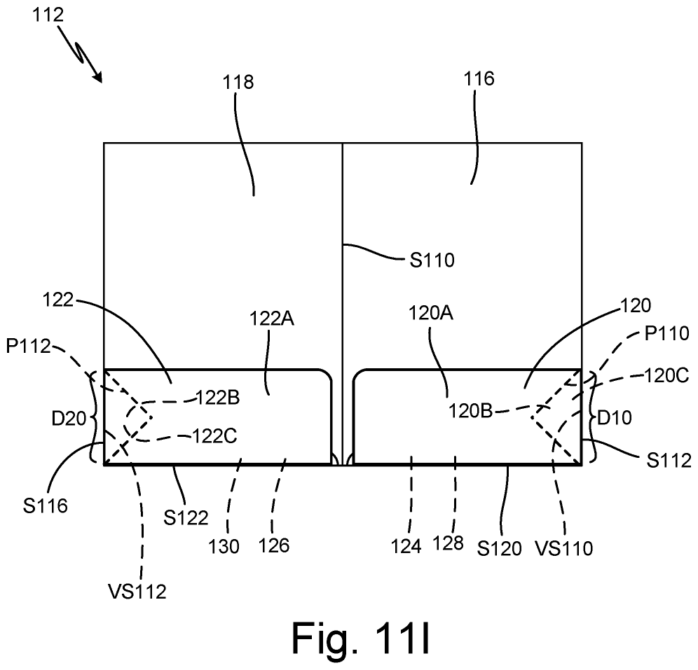

FIG. 10 is a flow chart showing an alternative method for forming a folder from printable blank sheet 110. FIG. 10 includes steps 164, 166, 168, 170, 172, 174, 176, 178, 180, 182, 184, 186, 188, 190, and 192 to show the alternative method for forming a folder from printable blank sheet 110. FIGS. 11A-11I illustrate steps 164-192 shown in the flow chart of FIG. 10. FIG. 11A is a perspective view of printable blank sheet 110 as it is being run through a printer. FIG. 11B is a top plan view of folder blank 112 after it has been removed from printable blank sheet 110. FIG. 11C is a bottom plan view of folder blank 112. FIG. 11D is a bottom plan view of folder blank 112 after first tab 124 and second tab 126 have been folded along first tab scored line S120 and second tab scored line S122. FIG. 11E is a bottom plan view of folder blank 112 as first adhesive cover 132 and second adhesive cover 134 are removed from first tab 124 and second tab 126. FIG. 11F is a bottom plan view of folder blank 112 after first pocket panel 120 and second pocket panel 122 have been folded along first dividing line DL110 and second dividing line DL 112. FIG. 11G is a bottom plan view of folder blank 112 after first pocket panel 120 and second pocket panel 122 have been folded along first diagonal perforated line P110 and second diagonal perforated line P112. FIG. 11H is a bottom plan view of folder blank 112 after first pocket panel 120 and second pocket panel 122 have been folded along first horizontal scored line S112 and second horizontal scored line S116. FIG. 11I is a bottom plan view of folder blank 112 after first tab 124 and second tab 126 have been adhered to first pocket panel 120 and second pocket panel 122.

Step 164 includes running printable blank sheet 110 through a printer or copier, as shown in FIG. 11A. Printable blank sheet 110 includes folder blank 112 that is positioned in printable blank sheet 110. Printable blank sheet 110 will be supplied to a user from a manufacturer and will contain periphery cut lines L1, first dividing line DL110, second dividing line DL112, first diagonal perforated line P110, second diagonal perforated line P112, and scored lines S1, as shown in FIG. 7, when it is given to the user. Periphery cut lines L1 will define the outline of folder blank 112 in printable blank sheet 110 and will indicate separation lines. In this embodiment, both sides of printable blank sheet 110 are capable of being printed on. Prior to printing on printable blank sheet 110, a template on a computer can be used to create the custom image that is to be printed on printable blank sheet 110, and specifically folder blank 112. A user can print on both sides of first body panel 116, second body panel 118, first pocket panel 120, and second pocket panel 122 so that information is viewable to users inside and outside of the folder. In alternate embodiments, only one side of printable blank sheet 110 may be printed on. In such embodiments, first pocket panel 120 and second pocket panel 122 are positioned such that a user can print on a top surface of printable blank sheet 110 so that information is viewable to users on outside surfaces of first body panel 116, second body panel 118, first pocket panel 120, and second pocket panel 122 after folder blank 112 has been formed into a folder using the following alternative method. Automatic imposition software can be used to create the design that is to be printed on printable blank sheet 110 and allows a user to create and orient the design so that it is positioned properly on folder blank 112 in printable blank sheet 110.

Step 166 includes separating folder blank 112 from printable blank sheet 110. Folder blank 112 is separated from printable blank sheet 110 along periphery cut lines L1. The user can bend printable blank sheet 110 along periphery cut lines L1, which define the periphery of folder blank 112 in printable blank sheet 110. In this embodiment, periphery cut lines L1 are slit-over perforation lines SP, and as printable blank sheet 110 is bent along slit-over-perforation lines SP, slit-over-perforation lines SP will snap apart. When periphery cut lines L1 are snapped apart, they will leave a clean edge on the portion of printable blank sheet 110 that has been separated. Bending printable blank sheet 110 along all of periphery cut lines L1 will break apart all periphery cut lines L1 and detach folder blank 112 from printable blank sheet 110. FIG. 11B shows folder blank 112 after it has been removed from printable blank sheet 110. Excess sheet area 114 can be discarded after folder blank 112 has been separated from printable blank sheet 110.

Step 168 includes flipping folder blank 112 over or around so that the bottom side of printable blank sheet 110 is exposed. FIG. 11C shows folder blank 12 after it has been flipped over.

Step 170 includes folding first tab 124 along first tab scored line S120, and step 172 includes folding second tab 126 along second tab scored line S122. First tab scored line S120 connects first tab 124 to first body panel 116. Second tab scored line S122 connects second tab 126 to second body panel 118. When first tab 124 is folded along first tab scored line S120, first tab 124 overlaps a bottom side of first body panel 116 such that first adhesive cover 132 is exposed. When second tab 126 is folded along second tab scored line S122, second tab 126 overlaps a bottom side of second body panel 118 such that second adhesive cover 134 is exposed. FIG. 11D shows folder blank 112 after first tab 124 and second tab 126 have been folded along first tab scored line S120 and second tab scored line S122.

Step 174 includes removing first adhesive cover 132 from first tab 124, and step 176 includes removing second adhesive cover 134 from second tab 126. First adhesive cover 132 covers first adhesive strip 128 on first tab 124, and second adhesive cover 134 covers second adhesive strip 130 on second tab 126. First adhesive cover 132 and second adhesive cover 134 can be peeled off of first adhesive strip 128 and second adhesive strip 130, respectively. As shown in FIG. 11E, first adhesive cover 132 and second adhesive cover 134 can be only partially peeled off of first adhesive strip 128 and second adhesive strip 130, respectively, such that a majority of first adhesive strip 128 and second adhesive strip 130 remain covered. As a result, first pocket panel 120 and second pocket panel 122 can be folded with proper alignment before being adhered to first tab 124 and second tab 126. The portions of first adhesive cover 132 and second adhesive cover 134 that have been peeled away form tabs that extend below first body panel 16 and second body panel 18, respectively. As a result, first adhesive strip 28 and second adhesive strip 30 are unexposed in areas adjacent first pocket panel 20 and second pocket panel 22, respectively. In alternate embodiments, the entireties of first adhesive cover 32 and second adhesive cover 34 can be peeled off to expose the entireties of first adhesive strip 28 and second adhesive strip 30.

Step 178 includes folding first pocket panel 120 along first dividing line DL110, and step 180 includes folding second pocket panel 122 along second dividing line DL112. When first pocket panel 120 and second pocket panel 122 are folded along first dividing line DL110 and second dividing line DL112, first pocket panel 120 and second pocket panel 122 are folded along first vertical cut line VL110 and second vertical cut line VL112, respectively, which are slit-over-perforation lines SP. As a result, first vertical cut line VL110 and second vertical cut line VL112 snap apart. A portion of first pocket panel 120 and a portion of second pocket panel 122 then become separated from first body panel 116 and second body panel 118. More specifically, first rectangular piece 120A and second rectangular piece 122A become separated from first body panel 116 and second body panel 118, respectively.

First vertical scored line VS110 of first dividing line DL110 connects first pocket panel 120 to first body panel 116, and second vertical scored line VS112 of second dividing line DL112 connects second pocket panel 122 to second body panel 118. More specifically, first vertical scored line VS110 connects first lower triangular piece 120C to first body panel 116, and second vertical scored line VS112 connects second lower triangular piece 122C to second body panel 118. When first pocket panel 120 is folded along first dividing line DL110, first pocket panel 120 is folded along first vertical scored line VS110 so that first pocket panel 120 overlaps first tab 124 and first body panel 116. First pocket panel 120 may also overlap first adhesive cover 132 and first adhesive strip 128, as shown in FIG. 11F. When second pocket panel 122 is folded along second dividing line DL112, second pocket panel 122 is folded along second vertical scored line VS112 so that second pocket panel 122 overlaps second tab 126 and second body panel 118. Second pocket panel 122 may also overlap second adhesive cover 134 and second adhesive strip 130, as shown in FIG. 11F. As first pocket panel 120 overlaps first adhesive cover 132 and second adhesive cover 134, first pocket panel 120 and second pocket panel 122 do not contact first adhesive strip 128 and second adhesive strip 130, respectively. FIG. 11F shows folder blank 112 after first pocket panel 120 and second pocket panel 122 have been folded along first dividing line DL110 and second dividing line DL112, respectively.

Step 182 includes folding first pocket panel 120 along first diagonal perforated line P110, and step 184 includes folding second pocket panel 122 along second diagonal perforated line P112. FIG. 11G shows folder blank 112 after first pocket panel 120 and second pocket panel 122 have been folded along first diagonal perforated line P110 and second diagonal perforated line P112, respectively. First diagonal perforated line P110 connects first upper triangular piece 120B to first lower triangular piece 120C, and second diagonal perforated line P112 connects second upper triangular piece 122B to second lower triangular piece 122C. As seen in FIG. 11G, first pocket panel 120 and second pocket panel 122 move from vertical positions to horizontal positons and extend away from first body panel 116 and second body panel 118 when folded about first diagonal perforated line P110 and second diagonal perforated line P112, respectively. As such, first upper triangular piece 120B overlaps first lower triangular piece 120C, and second upper triangular piece 122B overlaps second lower triangular piece 122C.

Step 186 includes folding first pocket panel 120 along first horizontal scored line S112, and step 188 includes folding second pocket panel 122 along second horizontal scored line S116. FIG. 11H shows folder blank 112 after first pocket panel 120 and second pocket panel 122 have been folded along first horizontal scored line S112 and second horizontal scored line S116, respectively. First horizontal scored line S112 connects first rectangular piece 120A to first upper triangular piece 120B, and second horizontal scored line S116 connects second rectangular piece 122A to second upper triangular piece 122B. As seen in FIG. 11H, first pocket panel 120 and second pocket panel 122 are in horizontal positions. First pocket panel 120 overlaps first adhesive cover 132, first adhesive strip 128, first tab 124, and first body panel 116 when folded along first horizontal scored line S112. Second pocket panel 122 overlaps second adhesive cover 134, second adhesive strip 130, second tab 126, and second body panel 118 when folded along second horizontal scored line S116. As such, first rectangular piece 120A overlaps first upper triangular piece 120B, first lower triangular piece 120C, first adhesive cover 132, first adhesive strip 128, first tab 124, and first body panel 116. Second rectangular piece 122A overlaps second upper triangular piece 122B, second lower triangular piece 122C second adhesive cover 134, second adhesive strip 130, second tab 126, and second body panel 118. Further, as seen in FIG. 11H, portions or tabs of first adhesive cover 132 and second adhesive cover 134 stick out from under first pocket panel 120 and second pocket panel 122.

Step 190 includes adhering first tab 124 to first pocket panel 120, and step 192 includes adhering second tab 126 to second pocket panel 122. The portions or tabs of first adhesive cover 132 and second adhesive cover 134 that stick out from under first pocket panel 120 and second pocket panel 122 can be pulled to fully remove first adhesive cover 132 and second adhesive cover 134, respectively. As a result, first adhesive strip 128 and second adhesive strip 130 are exposed in their entirety. As first pocket panel 120 overlaps first adhesive strip 128 and first tab 124, first pocket panel 120 comes into contact with first adhesive strip 128, adhering first pocket panel 120 to first tab 124. As second pocket panel 122 overlaps second adhesive strip 130 and second tab 126, second pocket panel 122 comes into contact with second adhesive strip 130, adhering second pocket panel 122 to second tab 126. More specifically, first rectangular piece 120A and first lower triangular piece 120C are adhered to first adhesive strip 128, adhering first rectangular piece 120A and first lower triangular piece 120C to first tab 124. Second rectangular piece 122A and second lower triangular piece 122C are adhered to second adhesive strip 130, adhering second rectangular piece 122A and second lower triangular piece 122C to second tab 126.

FIG. 11I shows folder blank 112 after first adhesive strip 128 and second adhesive strip 130 have been fully removed, and first pocket panel 120 and second pocket panel 122 have been adhered to first tab 124 and second tab 126, respectively. When first tab 124 is adhered to first pocket panel 120, first pocket panel 120 is secured in a horizontal position on first body panel 116. When second tab 126 is adhered to second pocket panel 122, second pocket panel 122 is secured in a horizontal position on second body panel 118. When first pocket panel 120 and second pocket panel 122 are secured in horizontal positions, first pocket panel 120 and second pocket panel 122 are pockets on folder blank 112 having depths represented by dimensions D10 and D20, respectively. First rectangular piece 120A and second rectangular piece 122A form faces of the pockets. First body panel 116 and second body panel 118 may be folded along center scored line S110 such that second body panel 118 forms a front of folder blank 112 and first body panel 116 forms a back of folder blank 112. The pockets formed by first pocket panel 120 and second pocket panel 122 are between first body panel 116 and second body panel 118 when first body panel 116 and second body panel 118 are folded along scored line S110.

The pockets of the folder formed by this alternative method differ from the pockets of the folder formed by the first method. The faces of the pockets formed by the first method are formed by first rectangular piece 120A, second rectangular piece 122A, first tab 124, and second tab 126, as seen in FIG. 9G. The faces of the pockets formed by this alternative method are completely formed by first rectangular piece 20A and second rectangular piece 22A, as seen in FIG. 11I. First tab 24 and second tab 26 are within the respective pockets formed by this method.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A folder blank comprising:
a first body panel;
a second body panel connected to the first body panel;
a first pocket panel connected to the first body panel;
a first diagonal line extending across the first pocket panel;
a first horizontal scored line connected to the first diagonal line and extending across the first pocket panel; and
a first dividing line extending between the first body panel and the first pocket panel, the first dividing line including:
a first vertical cut line; and
a first vertical scored line in alignment with and connected to the first vertical cut line;
wherein the first pocket panel can be folded about the first dividing line, the first diagonal line, and the first horizontal scored line to move the first pocket panel from a vertical position to a horizontal position on the folder blank.

2. The folder blank of claim 1, further including:
a first tab connected to the first body panel along a first tab scored line;
a first adhesive strip positioned on the first tab; and
a first adhesive cover positioned over the first adhesive strip.

3. The folder blank of claim 1, wherein the first vertical cut line is a slit-over-perforation line, the slit-over-perforation line including:
cuts running through a first layer of the folder blank; and
perforations running through a second layer of the folder blank, the second layer attached to a bottom side of the first layer, and the perforations being underneath the cuts running through the first layer.

4. The folder blank of claim 1, wherein the first vertical scored line is connected to the first diagonal line and the first horizontal scored line.

5. The folder blank of claim 1, wherein the first diagonal line extends at a 45 degree angle from the first horizontal scored line.

6. The folder blank of claim 1, the first pocket panel including:
a first rectangular piece connected to the first body panel along the first vertical cut line;
a first upper triangular piece connected to the first rectangular piece along the first horizontal scored line; and
a first lower triangular piece connected to the first upper triangular piece along the first diagonal line and connected to the first body panel along the first vertical scored line.

7. The folder blank of claim 1, further including:
a second pocket panel connected to the second body panel,
a second diagonal line extending across the second pocket panel;
a second horizontal scored line connected to the second diagonal line and extending across the second pocket panel; and
a second dividing line extending between the second body panel and the second pocket panel, the second dividing line including:
a second vertical cut line; and
a second vertical scored line in alignment with and connected to an end of the second vertical cut line;
wherein the second pocket panel can be folded about the second dividing line, the second diagonal line, and the second horizontal scored line to move the second pocket panel from a vertical position to a horizontal position on the folder blank.

8. The folder blank of claim 7, further including:
a second tab connected to the second body panel along a second tab scored line;
a second adhesive strip positioned on the second tab; and
a second adhesive cover positioned over the second adhesive strip.

9. The folder blank of claim 7, wherein the second vertical scored line is connected to the second diagonal line and the second horizontal scored line.

10. A printable blank sheet comprising:
the folder blank of claim 1; and
an excess sheet area surrounding the folder blank.

11. The printable blank sheet of claim 10, wherein a periphery cut line extends through the printable blank sheet and around the folder blank to define a periphery of the folder blank in the printable blank sheet.

12. The folder blank of claim 1, wherein the first body panel and the second body panel are positioned between the first pocket panel and the second pocket panel when the first pocket panel and the second pocket panel are in vertical positions.

13. A method for creating a custom folder, the method comprising:
folding a first pocket panel of a folder blank along a first dividing line of the folder blank, the folder blank including:
a first body panel connected to the first pocket panel;
a second body panel connected to the first body panel;
a first diagonal line extending across the first pocket panel; and
a first horizontal scored line connected to the first diagonal line and extending across the first pocket panel;
wherein the first dividing line extends between the first body panel and the first pocket panel, the first dividing line including:
a first vertical cut line; and
a first vertical scored line in alignment with and connected to the first vertical cut line;
folding the first pocket panel along the first diagonal line to move the first pocket panel from a vertical position to a horizontal position; and
folding the first pocket panel along the first horizontal scored line.

14. The method of claim 13, and further including:
removing a first adhesive cover from a first tab;
folding the first tab along a first tab scored line; and
adhering the first tab to the first pocket panel with the first adhesive strip.

15. The method of claim 14, wherein the first tab is connected to the first body panel along the first tab scored line.

16. The method of claim 13, further including:
folding a second pocket panel of the folder blank along a second dividing line of the folder blank, the second pocket panel being connected to the second body panel, the folder blank further including:
a second diagonal line extending across the second pocket panel; and
a second horizontal scored line connected to the second diagonal line and extending across the second pocket panel;
wherein the second dividing line extends between the second body panel and the second pocket panel, the second dividing line including:
a second vertical cut line; and
a second vertical scored line in alignment with and connected to the second vertical cut line;
folding the second pocket panel along the second diagonal line to move the second pocket panel from a vertical position to a horizontal position;
folding the second pocket panel along the second horizontal scored line;

17. The method of claim 16, further including:
removing a second adhesive cover from a second tab;
folding the second tab along a second tab scored line;
adhering the second tab to the second pocket panel with the second adhesive strip.

18. The method of claim 13, further including:
running a printable blank sheet comprising the folder blank of claim 11 through a printer; and
separating the folder blank from the printable blank sheet.

19. The method of claim 18, wherein separating the folder blank from the printable blank sheet includes bending the printable blank sheet along slit-over-perforation lines between the folder blank and excess sheet area of the printable blank sheet, the slit-over-perforation lines including:
cuts running through a first layer of the folder blank; and
perforations running through a second layer of the folder blank, the second layer attached to a bottom side of the first layer, and the perforations being underneath the cuts running through the first layer.

20. The method of claim 19, wherein the slit-over-perforation lines further include perforations running through a third layer along the slit-over-perforation lines, the third layer being a coating layer that is applied to a bottom side of the second layer.
